(19) United States
(12) Patent Application Publication
(10) Pub. No.: US 2026/0050896 A1
(43) Pub. Date: Feb. 19, 2026

(54) APPROACH FOR EXPRESSING RICH PERSONALIZED INFORMATION IN A LIMITED NOTIFICATION MESSAGE

(71) Applicant: Meta Platforms Technologies, LLC, Menlo Park, CA (US)

(72) Inventors: Chuming Zhao, Bellevue, WA (US); Yu-Chun Hsu, San Jose, CA (US); Tetsuro Oishi, Bothell, WA (US); Limin Zhou, Redmond, WA (US); Lichuan Chen, Kirkland, WA (US); Christopher Aholt, Newcastle, WA (US); Timo Nicolas Johannes Stoffregen, Zurich (CH); Ziliu Li, Redmond, WA (US)

(21) Appl. No.: 19/259,260

(22) Filed: Jul. 3, 2025

Related U.S. Application Data
(60) Provisional application No. 63/667,520, filed on Jul. 3, 2024.
(60) Provisional application No. 63/675,976, filed on Jul. 26, 2024.
(60) Provisional application No. 63/684,230, filed on Aug. 16, 2024.
(60) Provisional application No. 63/684,235, filed on Aug. 16, 2024.

(51) Int. Cl. G06Q 50/00

(52) U.S. Cl. CPC G06Q 50/01

(57) ABSTRACT

A method may include (1) identifying, using a machine-learning-based summarization model, interests of a user of a social media network, (2) extracting, using the machine-learning-based summarization model, information from a post to the social media network that aligns with the user's interests, and (3) generating, using the machine-learning-based summarization model, a personalized notification message for the user that is based on the information extracted from the post that aligns with the user's interests. Various other methods and systems are disclosed.

### CROSS REFERENCE TO RELATED APPLICATION

This application claims the benefit of U.S. Provisional Application No. 63/667,520, filed 3 Jul. 2024, which claims the benefit of U.S. Provisional Application No. 63/675,976, filed 26 Jul. 2024, which claims the benefit of U.S. Provisional Application No. 63/684,230, filed 16 Aug. 2024, which claims the benefit of U.S. Provisional Application No. 63/684,235, filed 16 Aug. 2024, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIGS. IA, IB and IC are schematic diagrams illustrating light sources causing specular reflections on a cornea, which appear as visible glints on an image sensor.

FIG. 2 is a schematic diagram illustrating one bit of a four-LED bit sequence for an event.

FIG. 3 is a chart illustrating an example of encoding each LED by a unique binary code, according to certain aspects of the disclosure.

FIG. 4 is a schematic diagram illustrating an example of using beacons to produce an alternating pattern of bright/dark pupil responses, according to certain aspects of the disclosure.

FIG. 5 is a schematic diagram illustrating an example transition of bright pupil (BP) LEDs and dark pupil (DP) LEDs, according to certain aspects of the disclosure.

FIG. 6 is a schematic diagram illustrating an example of a prototype of the bright/dark pupil illumination system, according to certain aspects of the disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

### Event-Sensor Bright/Dark Pupil Tracking

### Technical Field

The present disclosure generally relates to eye tracking, and more particularly, to an event-sensor bright/dark pupil (ESBDP) tracking.

### Background

The pupil is retroreflective in the NIR, so when the eye is illuminated by a NIR light source along the camera axis, the pupil appears very bright. If the eye is illuminated off axis, the pupil appears dark. This is known as bright/dark pupil respectively. By alternating between a bright and a dark pupil light source at a known frequency, the apparent brightness of the pupil will alternate at that frequency. By recording this with an event sensor, events can be generated at the pupil at that frequency, which can be decoded using frequency filtering. In this way the approach is similar to existing works such as corneal glint tracking using an event sensor (Stoffregen et al) or active LED markers (ALMs).

ALMs are also commonly used to calibrate event cameras, in products such as the propheshield (a device used to calibrate an event-based camera) or the dynamic vision sensor (DYS) calibration software. To achieve this, LEDs are arranged in a predetermined grid pattern and flashed at fixed frequencies. LED locations on the image sensor can be determined through frequency filtering, facilitating calibration.

A bright pupil effect is commonly used in camera-based pupil detection and tracking and is generated by illuminating the eye with a near-infrared light that is on or near the optical axis of the camera. A shortcoming of this approach is that it is brittle, often relying on brightness thresholds and is sensitive to occlusions by eyelashes or other objects. At the same time, differential lighting with event sensor is currently used to great effect to track corneal glints, which can be used to generate events on the pupil, as disclosed herein.

### SUMMARY

The subject disclosure is directed to a method of event sensor bright/dark pupil tracking that includes using beacons to produce an alternating pattern of bright/dark pupil responses.

These changes in the apparent brightness of the pupil can be recorded using an event sensor and decoded using frequency filtering to find the exact location of the pupil. This is similar to finding glints using beacons to produce coded differential lighting. Bright/dark pupil with event sensors may be combined with corneal glint tracking to perform full eye tracking.

### BRIEF DESCRIPTION OF THE DRAWINGS

To easily identify the discussion of any particular element or act, the most significant digit or digits in a reference number refer to the figure number in which that element is first introduced.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, a subwavelength meta-NEMS optical phased array for holographic projection is described. It will be apparent, however, to one ordinarily skilled in the art, that the embodiments of the present disclosure may be practiced without some of these specific details. In other instances, well-known structures and techniques have not been shown in detail so as not to obscure the disclosure.

The approach of the subject disclosure is for pupil tracking by ESBDP. The present disclosure makes use of the bright pupil effect. The pupil is very reflective in the near-infrared (NIR), so when the eye is illuminated by an NIR light source along the camera axis, the pupil appears very bright. If the eye is illuminated off axis, the pupil appears dark. By rapidly switching between two such light sources, we can cause the pupil to appear to flash, which will generate many events in the event sensor. At the same time, the total brightness in the scene is compensated by the two light sources, so no or few events are generated in the background (differential lighting). By frequency filtering the resulting events, we can filter out exactly those events coming from the pupil. This makes event-based bright pupil detection much more robust than with standard camera-based methods.

Pixels in an event camera operate asynchronously and independently, reporting changes in intensity as events=tuples of (x,y) position, polarity sand timestamp tat microsecond resolution. Event cameras operate at low power (e.g., about 5 mW) and respond to changes in the scene with a latency on the order of microseconds. These properties make event cameras an exciting candidate for eye tracking sensors on mobile platforms such as Augmented/Virtual Reality (AR/VR) headsets, since these systems have hard real-time and power constraints. One proven method for eye tracking and gaze estimation is corneal glint detection. We exploit the fact that corneal glint tracking only requires a sparse set of pixels in the image, by making use of the natural sparsity of event cameras, which only detect changes in the scene. To enhance this effect, we design an illumination scheme, Coded Differential Lighting, which enhances specular reactions, suppresses all other events, and solves the light-to-glint correspondence. This is the first purely event-based corneal glint detection and tracking algorithm, which operates on standard hardware at kHz sampling rate.

In some implementations, instead of sampling all pixels at a fixed frame rate as in conventional cameras, the pixels of an event camera independently report changes in log intensity. Events, represented as a tuple of (x, y) position, polarity sand timestamp t, trigger whenever the measured log intensity changes by more than a preset threshold. This allows event data to be efficient and sparse, since only scene changes are recorded. Event cameras shave high dynamic range (e.g., about 120 dB), almost no motion blur, draw less power than conventional cameras, and report events at sub-millisecond latency.

Event cameras are a good fit for eye-tracking sensors in augmented reality (AR) and/or virtual reality (VR) headsets, since they fulfil key requirements on power and latency. Head-mounted displays (HMDs) used in AR/VR must be low power, both to extend the battery life of mobile systems and to reduce the amount of heat generated by the headset. Further, eye tracking needs to operate at high sampling rate, to allow adaptive display technologies to operate seamlessly, and for applications like user authentication which can require up to 1 kHz sampling.

Many moderm video-based eye-tracking systems use pupil center corneal reflection (PCCR). This approach works by shining light sources (e.g., in the infrared spectrum) at the eye. This induces specular reflections, known as glints, on the surface of the cornea, which can be detected by the camera as bright peaks and then used to estimate the position of the corneal sphere. At the same time the pupil, which appears as a dark ellipse, is detected. The gaze vector can be estimated by computing a vector between the centers of the pupil ellipse and corneal sphere.

The subject disclosure is directed to an event-based glint-detection algorithm, which is lightweight, operates at 1 KHz sampling rate, and efficiently solves the light-to-glint correspondence problem. By pulsing the illumination at high frequency, the event camera produces events at the glint reflections, as desired. However, rapidly changing illumination also causes events in the rest of the image (skin, iris, sclera, etc.), which can exceed the event-rate of the camera and eliminate the power benefits of the sensor. It is demonstrated that a new lighting scheme for event cameras, coded differential lighting (CDL), preserves the events at specular reflections while suppressing events from diffuse parts of the scene. By using a compensatory paired-light-emitting diode (LED) stimulus in which one light in the pair turns off as the other turns on, the net illumination remains approximately constant, while specular reflections move lightly. This enhances the glint signal while suppressing on-glint events.

While increasing the number of corneal glints improves gaze vector estimates, it introduces the challenging problem of robustly finding the correspondence between light sources and corneal glints. The disclosed solution works by pulsing the light sources for two known periods, with each period encoding either 1 or Obits. Each glint is identified through a unique binary pattern of these pulses. By frequency filtering the event stream, the subject technology not only removes unwanted sources of noise (such as events caused by changes in background lighting), but unambiguously identifies each glint with respect to (w.r.t.) the corresponding light source.

In some implementations, a method of event-sensor bright/dark pupil tracking includes using beacons to produce glints from the cornea, using a camera to detect events associated with the glints, and filtering events triggered by the beacons to remove background. The beacons are generated by two light sources, and wherein a first light source of the two light sources is illuminating the cornea along an axis of the camera.

In some implementations, the method further includes using the filtered events to calculate a location associated with each glint.

In one or more implementations, a second light source of the two light sources is illuminating the cornea off axis of the camera.

In some implementations, illuminating the cornea is by using near-infra-red (NIR) light from the two sources.

In one or more implementations, filtering the events comprises frequency filtering to remove events originating from the background.

In some implementations, the method further includes compensating a total brightness by the two light sources to limit the number of events generated in the background.

In one or more implementations, the method further includes updating calculated glint locations at a high frequency, wherein the high frequency is within a range of about 1 kHz to 2 kHz.

In some implementations, the method further includes rapidly switching between the first light source and the second light source.

Aspects of the subject matter described in this disclosure can be implemented to realize one or more of the following potential advantages.

Turning now to the figures, FIGS. 1A, IB and IC are schematic diagrams illustrating light sources causing specular reflections on a cornea, which appear as visible glints on an image sensor. FIG. 1A shows how the light sources (on the left) can cause specular reflections on an eye cornea. These glints can be used to locate the corneal sphere for gaze estimation.

FIG. 1B depicts that the light sources are pulsed in a binary sequence at high frequency. To prevent stimulating events across the entire scene, each light source is paired with a compensating light, so that the net illumination remains constant, but the specular cornea produces events.

FIG. 1C shows how the binary patterns in the event stream are decoded for kHz glint tracking. Red and cyan boxes show 0- and 1-bit glints for one bit sequence. The glint traces are shown in hue, saturation and value (HSY) color in this real-eye saccadic sequence, with events overlayed as red and blue points.

We model the corneal glints as ideal specular reflections on a perfect sphere. Under these assumptions, there is exactly one ray which passes from each light source to the corresponding glint and from each glint to the corresponding point on the image plane (see FIG. 1). Since the light locations in camera coordinates are fixed and known from device calibration, we can determine the corneal sphere dimensions and location by optimizing the reprojection error of the lights onto the image plane. That is, we solve the problem: 0*=arg. We model the corneal

glints as ideal specular reflections on a perfect sphere. Under these assumptions, there is exactly one ray which passes from each light source to the corresponding glint and from each glint to the corresponding point on the image plane (see FIG. 1). Since the light locations in camera coordinates are fixed and known from device calibration, we can determine the corneal sphere dimensions and location by optimizing the reprojection error of the lights onto the image plane. That is, we solve the problem:

$$\_ * {}^{″} 1 n 1 ed ( ) 2 L … n = 1 Xrn - Xen ( 2 ) 0$$

where 0 is the optimization variable represented as a vector [xe, Ye, Ze, rcJT of the cornea sphere position Xe, Ye, Ze and radius r in camera coordinates, nled is the number of LEDs, Xrn is the reprojected location on the camera plane of LED n, and Xen is the detected location of the glint caused by LED n. We solve this problem using line-search based gradient decent using numeric derivatives.

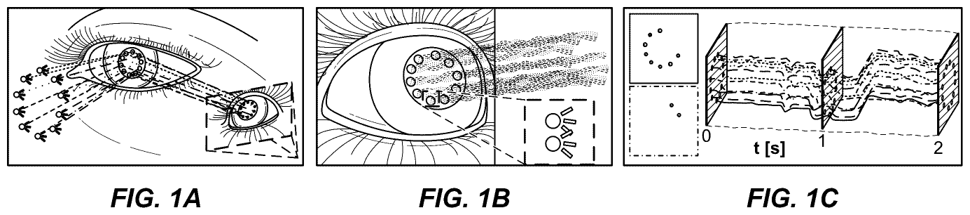

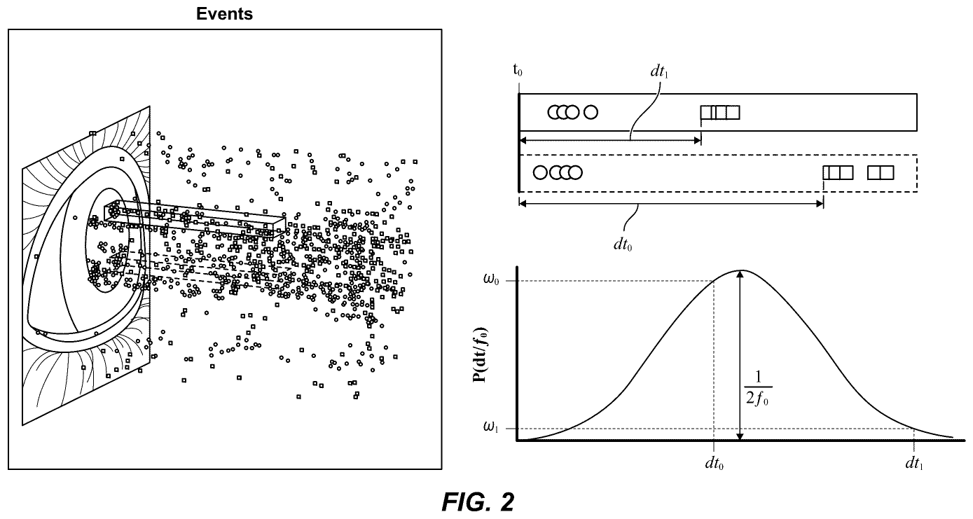

FIG. 2 is a schematic diagram illustrating one bit of a four-LED bit sequence for an event. Events in the cyan box (top) are from a short O pulse, events in the purple box (bottom) are from a long 1 pulse. For an event in the purple box with time dtO, the weight for the 0-bit filter, wO(equal to the normal pdf P(dtOlf0)), is much larger than the corresponding weight for the 1-bit filter, w1, allowing per-pixel filtering of the O and 1 frequency bands. Note the delay between lights switching ON at tOand subsequent event generation.

Cheap frequency filtering of the event stream is key to our method. Given a stream of events e={(x, y), t, s} from a set of events£, we wish to locate the subset £1 on the image plane, produced by a beacon switching with period T= [symbol] −Previous methods detect the transition period at each pixel dt by measuring the time between the first event of polarity s to the first event of opposite polarity sf. The likelihood (or weight) w of each dt being explained by the target frequency is modeled by a normal distribution:

The standard deviation of the distribution CY is a tunable parameter which sets the bandwidth of the frequency filtering and is dependent on the properties of the event camera used. It is found that a value of 80 Hz works well.

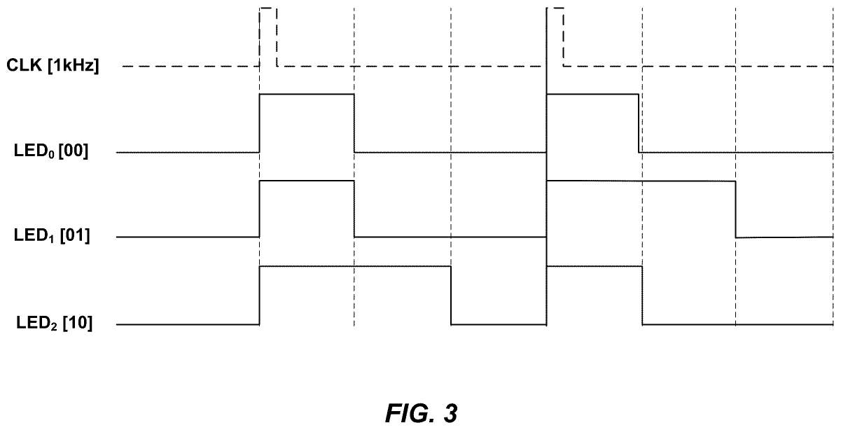

Leveraging electronic synchronization between LEDs and cameras, the formulation for dt as the period between the synchronization pulse t0 and the first event of polarity sP is modified. This allows for more accurate filtering, since the variation in event timestamps from the initial LED state change is eliminated, as shown in FIG. 3, and provides a mechanism for separating glints from the primary and compensatory LEDs (sp=−1 for primary and sP=1 for compensatory glints). For additional robustness to noise, a threshold is introduced such that at least Ac=2 successive events of polarity sP need to be detected to count as a transition. The result is a frequency filter (FF) image, formed by summing the transition weights w at each pixel location.

FIG. 3 is a chart illustrating an example of encoding each LED by a unique binary code, according to certain aspects of the disclosure. To represent each bit, the base frequency f (lkHz) is divided into three segments, with 1 represented by a long pulse of [symbol] s and O by a short pulse 3f of1-s 3f.

One option to encode glint (or more generally, beacon) identity is to assign a unique frequency to each. However, in the case of current state of the art (SotA) event cameras, this limits the number of glints that can be robustly tracked at [symbol] 1 KHz to about 5. This is because the actual transition periods implied by the event camera fall into a distribution that spans several hundred Hz, while frequencies above 2 kHz exceed sensor capabilities.

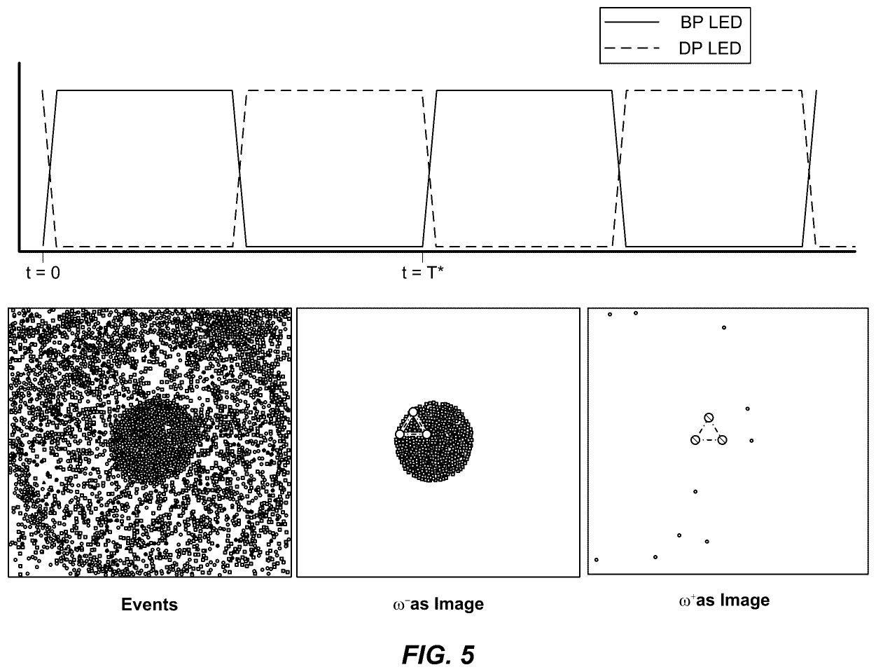

This motivates introduction of a binary coding scheme, in which each LED flashes a unique binary sequence in which O is represented as a short pulse of period T0 and 1 as a longer pulse of period T1, as shown in the chart of FIG. 5. This allows supporting arbitrarily many beacons while only requiring two frequencies to be filtered, which the 1-2 kHz band can easily support (FIG. 3). This may appear to reduce the sampling-rate for each beacon, since log2(N) bits are needed for N beacons; however, since we track each beacon over time, we can update the location on every bit once the beacon tracker is initialized. The sampling-rate is equal to the clock frequency, 1 kHz in the present case.

A limitation of event-based sensors is that unexpected changes of brightness can produce many unwanted (spurious) events, which may cause errors in downstream tasks. Some examples are flickering halogen lights, PWM dimmed monitors, lens flare, or unmodelled camera/back-ground motions. By filtering out these relatively low-frequency sources of spurious events, the disclosed method is unaffected by invasive light sources or facial movements which might induce spurious events in an HMD. It can demonstrate this by recording the corneal glints of a realistic eye model embedded in a model head. A bright light source illuminates the scene at a fixed frequency, causing large brightness shifts in the surrounding eye and facial region being recorded. The results of this experiment in Table 2 below show that the disclosed method retains sub-pixel accuracy even when scene noise dominates the signal.

| f [Hz] | 1 | 5 | 10 | 20 | 50 | 100 |
|---|---|---|---|---|---|---|
| Mevis | 5.19 | 5.20 | 5.21 | 5.61 | 11.3 | 23.2 |
| SNR | 5345 | 4611 | 401 | 8.83 | 0.63 | 0.18 |
| Err[pix] | 0.13 | 0.13 | 0.14 | 0.16 | 0.78 | 4.97 |

Table 2 shows the effect of background events generated by an external light source flashing at fe Hz on the event rate (Mevis), SNR and glint detection error (pix).

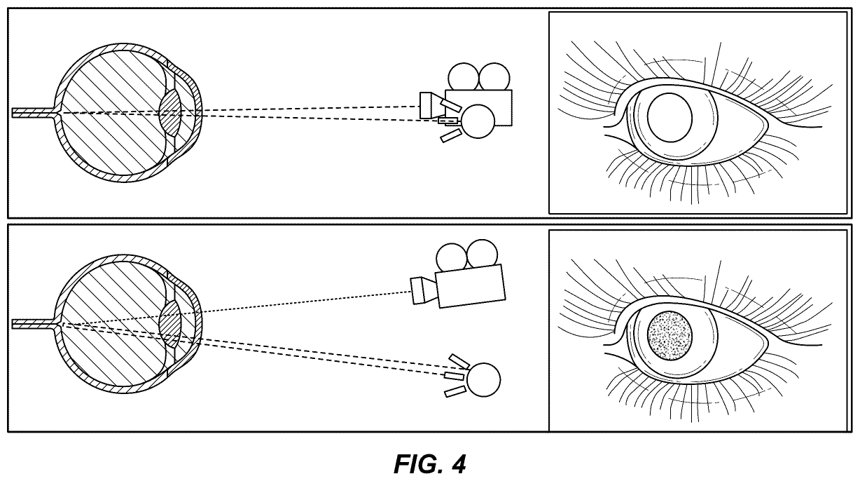

It should be noted that the sampling function (Equation 1), reduces the required bandwidth, since it weights values that are far from the actual frequency as essentially zero. One way to think of this, is that the sampling function is multiplied with D to produce a distribution W with a smaller support (WN(CJ)XD). However, this comes at the cost of throwing 2f away information from D. It is found that CJ5=80 Hz is the smallest sample function standard deviation to give robust results, allowing [symbol] 4 unique frequencies in the 12 kHz band (in agreement with the literature). In contrast to the above discussion, the disclosed binary encoding scheme is unaffected by issues of limited bandwidth. FIG. 4 is a schematic diagram illustrating an example of using beacons to produce an alternating pattern of bright/dark pupil responses, according to certain aspects of the disclosure. The top portion of FIG. 4 shows a first scenario where the light is shone on-axis with the pupil, causing the pupil to appear bright (bright pupil). The bottom portion of FIG. 4 depicts a second scenario where the light is shone off-axis, causing the pupil to appear dark (dark pupil).

FIG. 5 is a schematic diagram illustrating an example transition of BP LEDs and DP LEDs, according to certain aspects of the disclosure. The plot on the top portion of FIG. 5 depicts variation, over a period T*, of the BP LEDs and the DP LEDs. During the period T*, the BP LEDs transition from an ON state to an OFF state, and the DP LEDs transition from the OFF state to the ON state. The result of these transitions is a set of events that can be filtered to extract only the pupil, as shown in the bottom portion of FIG. 5.

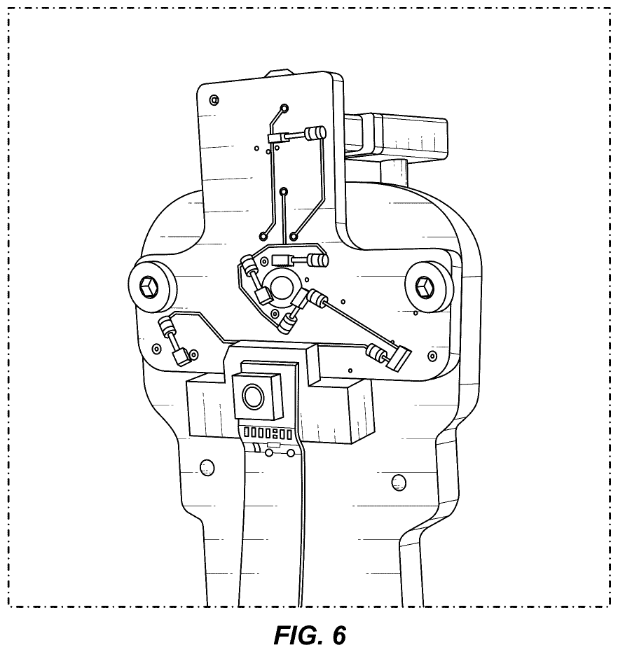

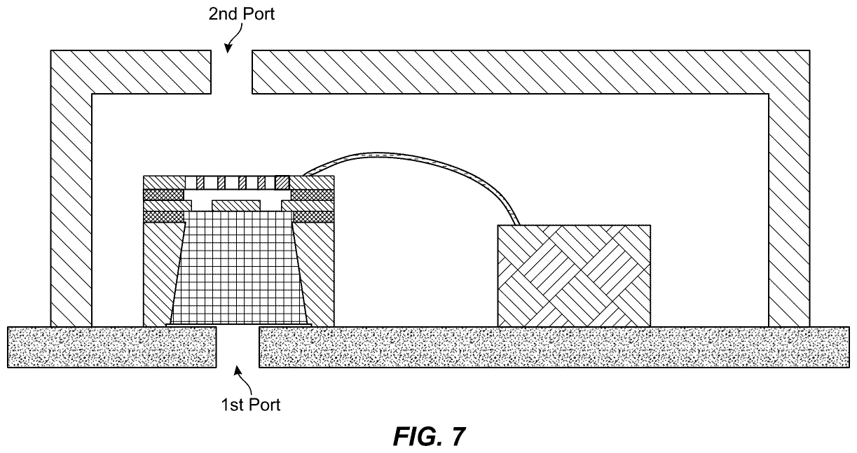

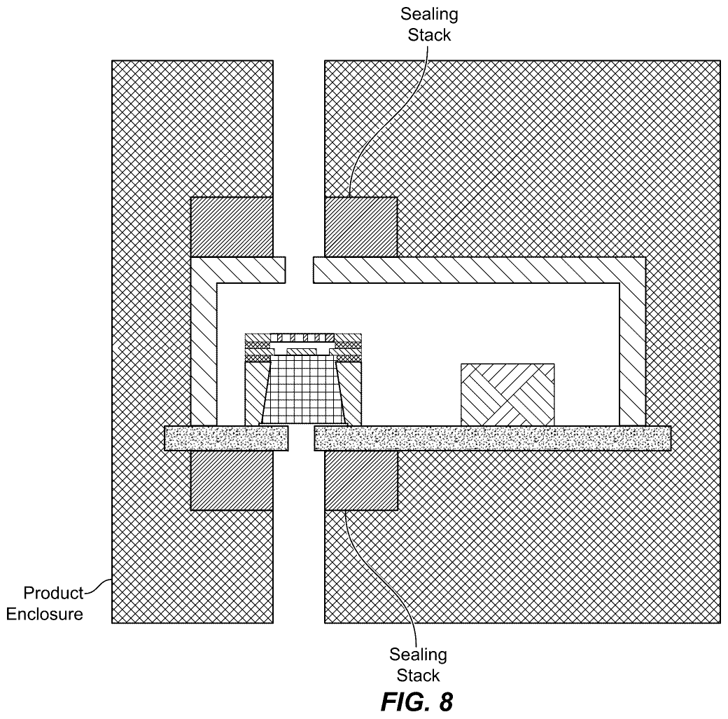

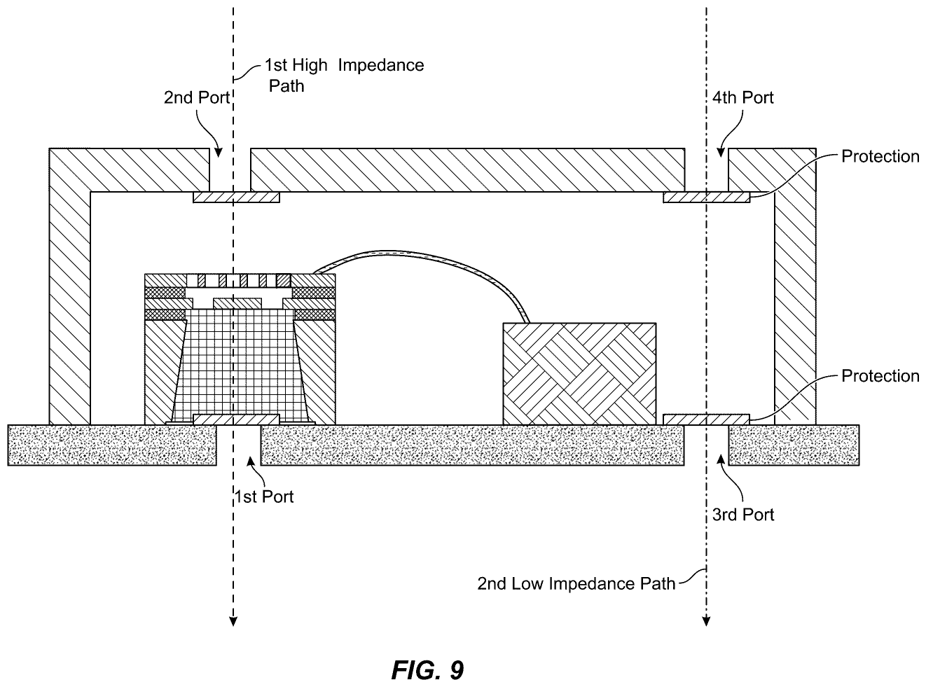

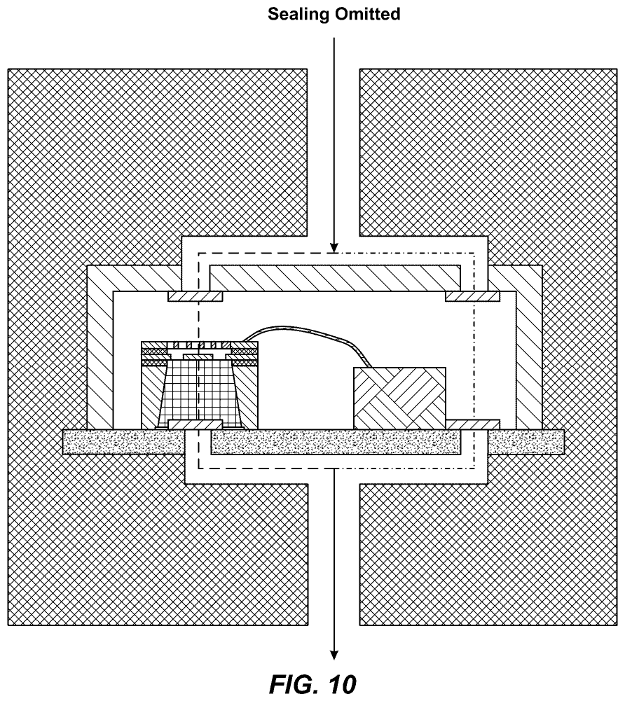

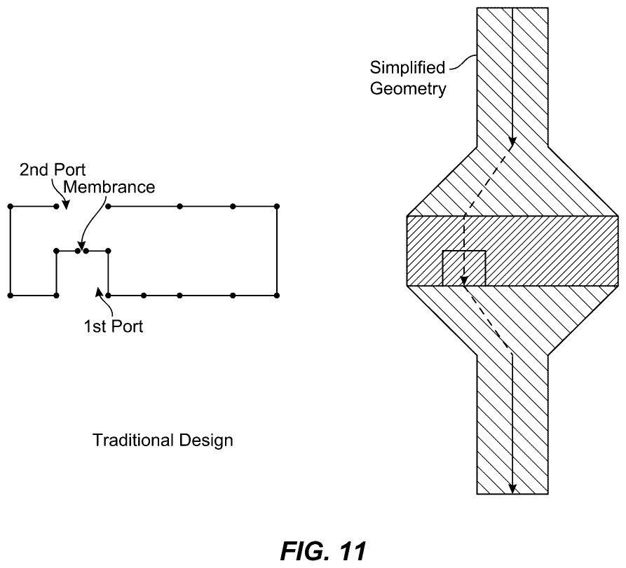

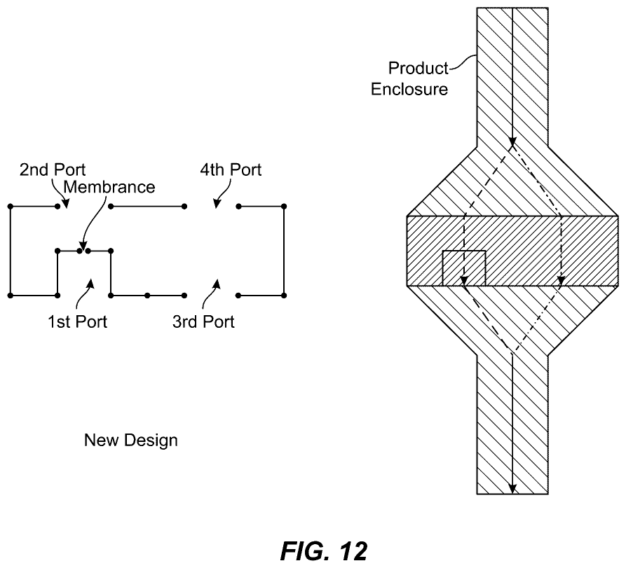

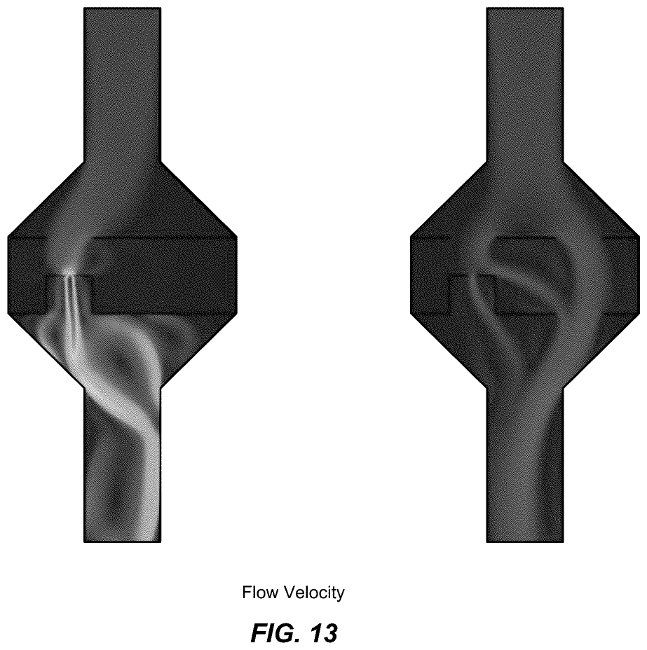

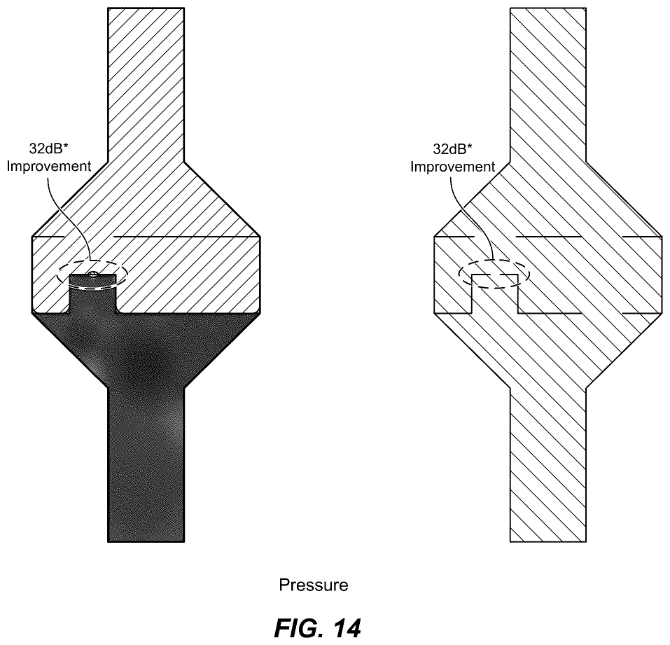

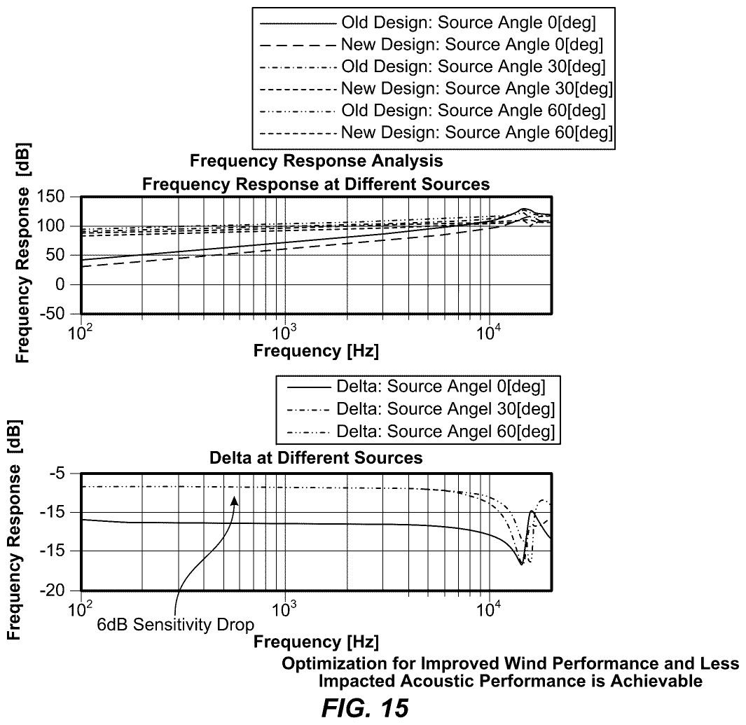

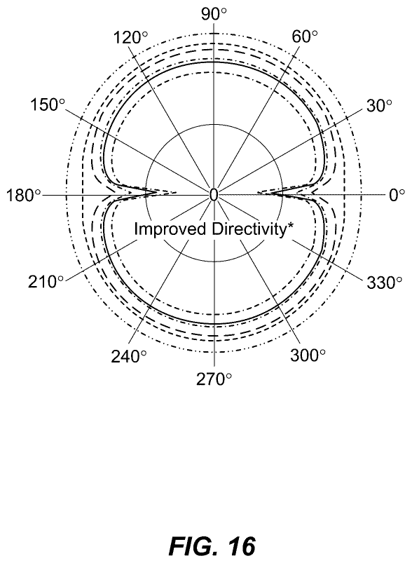

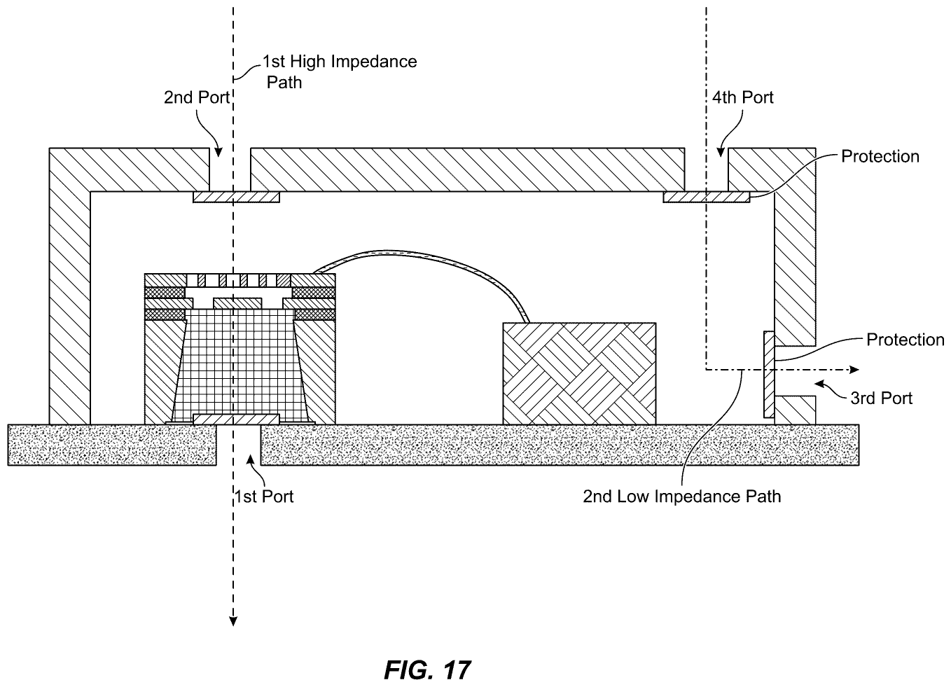

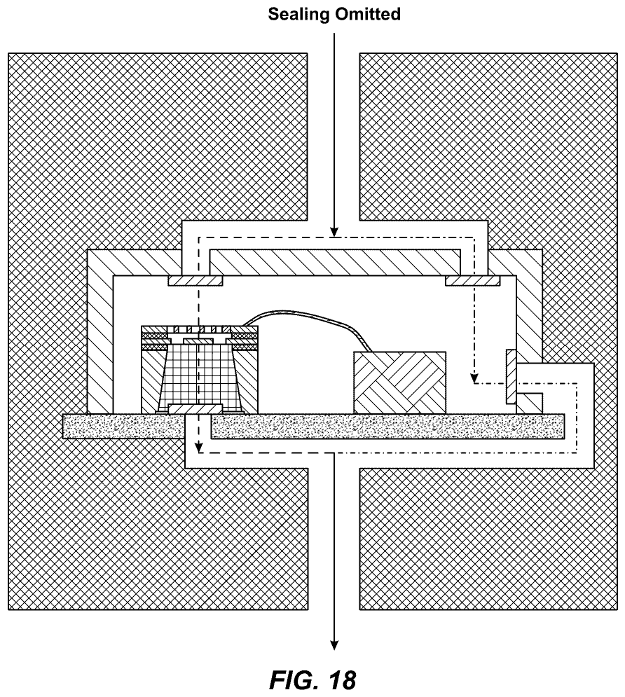

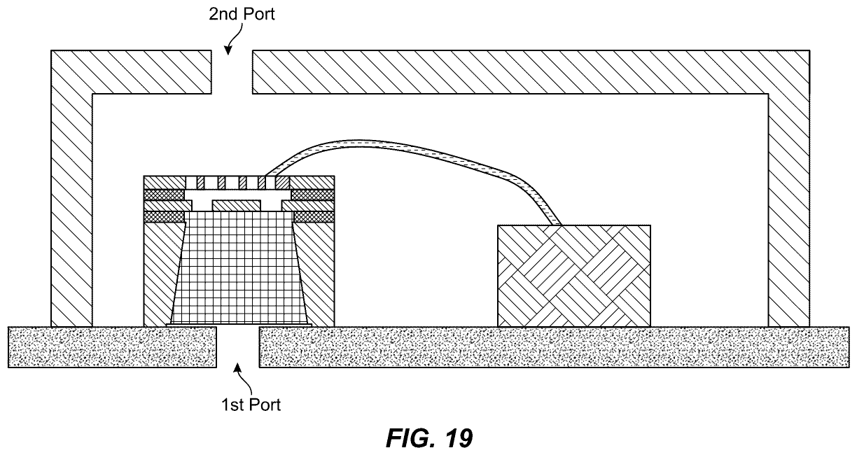

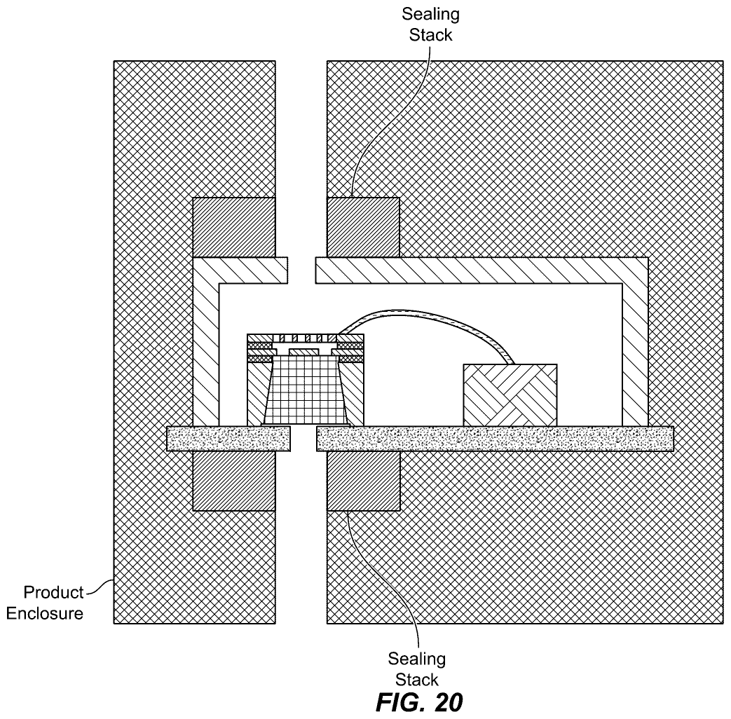

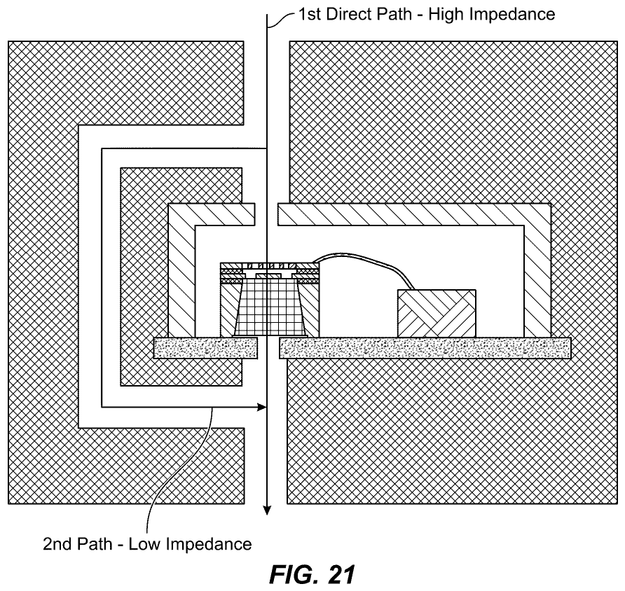

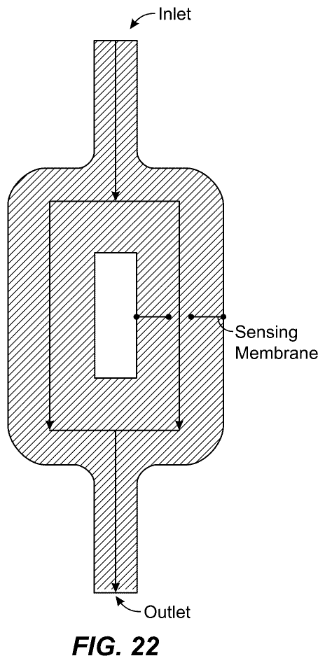

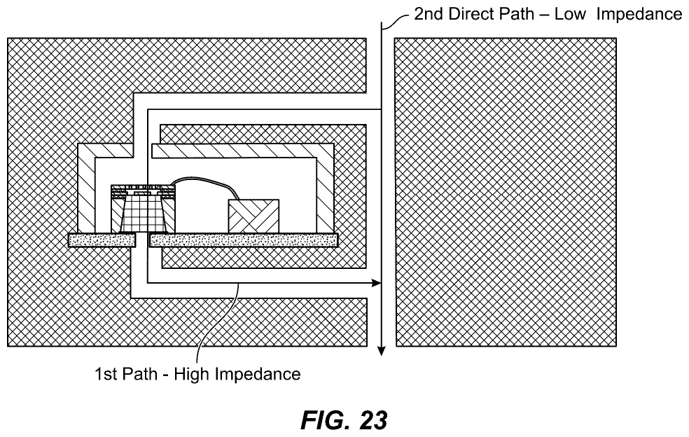

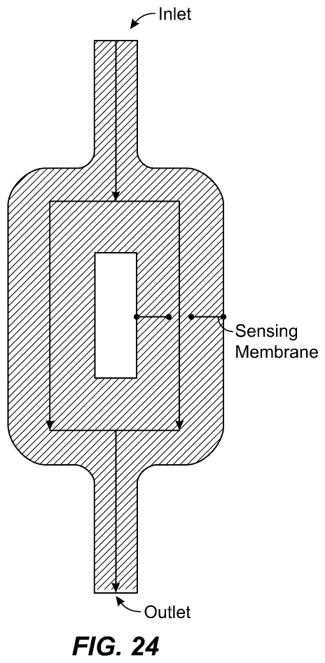

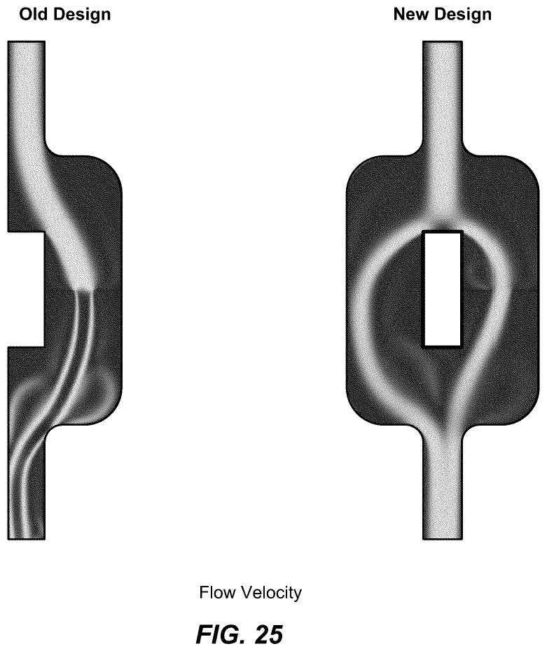

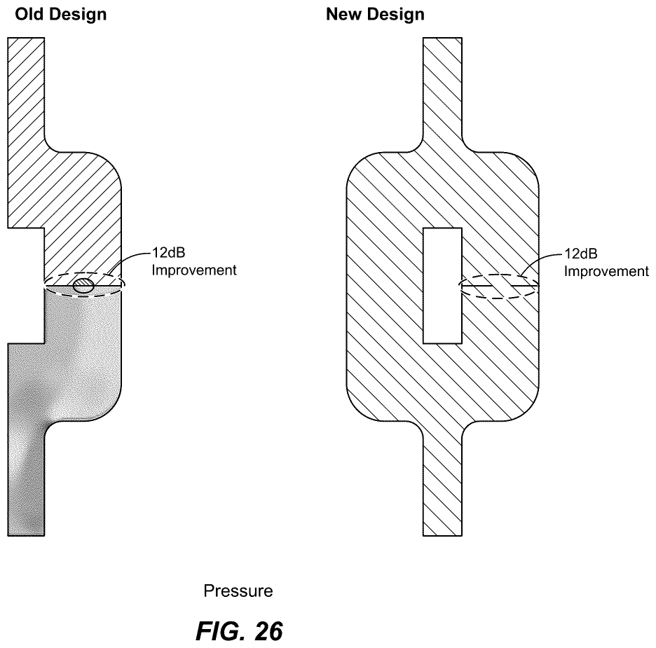

FIG. 6 is a schematic diagram illustrating an example of a prototype of the bright/dark pupil illumination system, according to certain aspects of the disclosure. The early prototype of the bright/dark pupil illumination, as shown in FIG. 6, includes DP LEDs, BP LEDs, an event sensor aperture and a reference camera. The reference camera does not play a role in the algorithm and is only included to gather standard camera images for comparisons.

In conclusion, the disclosed subject technology directed is to a method of event sensor bright/dark pupil tracking that includes using beacons to produce an alternating pattern of bright/dark pupil responses. These changes in the apparent brightness of the pupil can be recorded using an event sensor and decoded using frequency filtering to find the exact location of the pupil. This is similar to finding glints using beacons to produce coded differential lighting. Bright/dark pupil with event sensors may be combined with corneal glint tracking to perform full eye tracking.as well as on real users, the use of event sensors in actual eye tracking solutions can be expected.

In an aspect the subject technology is directed to an apparatus comprising a DP LED, a BP LED, an event sensor and a reference camera.

In some aspects, the apparatus is used for event sensor bright/dark pupil tracking.

In one or more aspects, the DP LEDs and BP LEDs are configured to produce an alternating pattern of bright/dark pupil responses.

In some aspects, the event sensor is configured to record changes in the apparent brightness of a pupil of a subject.

In one or more aspects, the event sensor is further configured to decode the changes in the apparent brightness of the using frequency filtering to find the exact location of the pupil.

In some aspects, the reference camera is configured to gather standard camera images for compansons.

Directional Mems Microphone Packaging Design with Improved Wind Performance

### Technical Field

The present disclosure generally relates to sensor devices, and more particularly, to a directional microelectron-mechanical system (MEMS) microphone packaging design with improved wind performance.

### Background

A directional microphone is a type of microphone that primarily picks up sounds from a specific direction. Unlike omnidirectional microphones, which capture sound from all directions, directional mies are more focused and sensitive in one or more specific directions. These microphones are commonly used in various audio recording scenarios, such as podcasts, voiceovers, and video production. A directional microphone is an excellent choice for superior isolation and reduced interference from surrounding noise. Directional microphones receive attentions with its good performance targeting at certain spatial angles and therefore performance beamforming functions on its own single sensor integration, which saves cost and eases integration.

However, for a typical directional microphone design, both sides of the sensing membrane are exposed to the external environment, and it is more susceptible to wind noise and maybe plosive sound. Historically, for most directional microphones, some wind treatment such as a wind socket, a heavy acoustic resistive mesh or some other wind treatment measure would be required.

### SUMMARY

The subject disclosure is directed to a directional MEMS microphone packaging design with improved wind performance that leverages a secondary low-impedance path within the directional microphone package, which helps direct the majority of air flows away from the sensing element with a high-impedance path.

### BRIEF DESCRIPTION OF THE DRAWINGS

To easily identify the discussion of any particular element or act, the most significant digit or digits in a reference number refer to the figure number in which that element is first introduced.

FIG. 7 is a schematic diagram illustrating an example of a structure of a directional microphone packaging, as discussed herein.

FIG. 8 is a schematic diagram illustrating an example structure of a directional microphone packaging, as discussed herein.

FIG. 9 is a schematic diagram illustrating a packaging structure of a directional microphone, according to certain aspects of the disclosure.

FIG. 10 is a schematic diagram illustrating a packaging structure of a directional microphone, according to certain aspects of the disclosure. \FIG. 11 is a schematic diagram illustrating a simplified model of a packaging structure of a traditional directional microphone for simulation, as discussed herein.

FIG. 12 is a schematic diagram illustrating a simplified model of a packaging structure of a directional microphone for simulation, according to certain aspects of the disclosure.

FIG. 13 is a schematic diagram illustrating example simulated flow velocities inside an existing and a disclosed directional microphone, according to certain aspects of the disclosure.

FIG. 14 is a schematic diagram illustrating example simulated pressures inside an existing and a disclosed directional microphone, according to certain aspects of the disclosure.

FIG. 15 shows charts illustrating example simulated frequency responses and differences, of a directional microphone of the subject technology.

FIG. 16 shows a chart illustrating an example simulated directivity of a directional microphone of the subject technology.

FIG. 17 is a schematic diagram illustrating a packaging structure of another embodiment of a directional microphone, according to certain aspects of the disclosure.

FIG. 18 is a schematic diagram illustrating a packaging structure of another embodiment of a directional microphone, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to a directional MEMS microphone packaging design with improved wind performance. The directional microphone of the subject technology leverages a secondary low-impedance path within the directional microphone package that helps direct a majority of air flows away from the sensing element, which is a higher impedance path. As a result, less residual turbulence energy is captured by the sensing membrane, and therefore a sensor with desirable beamforming performance in the presence of the air flows is achieved. The disclosed directional microphone package design enables the outdoor use of mixed reality (MR), augmented reality (AR) or other wearable devices in the presence of air flows.

A traditional MEMS directional microphone has desired beamforming patterns by itself without a microphone array. However, it's sensitive to air flows, such as wind, as the sensing membrane is exposed to air flows from both sides. The turbulence energy is readily captured by the membrane because other than the holes on the sensing element, no outlet for the airflow is available within the package. Therefore, the performance of traditional directional microphones is degraded due to the presence of air flows. The degradation issue limits the outdoor use of the traditional directional microphones on devices such as MR, AR and other wearable devices.

In some implementations, an apparatus of the subject technology includes a first airflow path through a sound-sensing structure and the second low-impedance airflow path. The first and the second airflow paths pass through an input port and an output port of an external enclosure (product enclosure).

In one or more implementations, the second airflow path is configured to be a direct path through a first enclosure of the apparatus.

In some implementations, the second airflow path is configured to direct major air flows from the first port to the second port with less residual turbulences.

In some implementations, the second airflow path is created on one of two sides of the first airflow path and the outlet port of the second path is placed on the opposite side of the inlet port on the first enclosure.

In one or more implementations, the second airflow path is created on one of two sides of the first airflow path and the outlet port of the second path is placed on a wall of the first enclosure.

In some implementations, the second airflow path is configured to improve the pressure within the first airflow path by about 32 dB.

In one or more implementations, the second airflow path is configured to improve the flow velocity uniformity within the first path.

In some implementations, the apparatus comprises a directional microphone.

Turning now to the figures, FIG. 7 is a schematic diagram illustrating an example structure of a directional microphone, as discussed herein. The directional microphone, as shown in FIG. 7, includes a first port and a second port. The first port is located in the substrate on which the sound-sensing structure and the support electronics are placed. The second port is located on a first enclosure across the first port and above the sound-sensing structure.

FIG. 8 is a schematic diagram illustrating an example structure of a directional microphone with an enclosure, as discussed herein. The directional microphone shown in FIG. 8 is structurally the same as the directional microphone of FIG. 7 within the first enclosure, except that in FIG. 8, a second enclosure (product enclosure) is added by using sealing stack components around the first and the second port of the first enclosure.

FIG. 9 is a schematic diagram illustrating a packaging structure of a directional microphone, according to certain aspects of the disclosure. The directional microphone of the subject technology, as shown in FIG. 9, includes a second path within the product structure. The first path is a high-impedance path because of the resistance due to the sound-sensing structure being on the way of the air flow. The second path is a direct path through a third port and a fourth port of the first enclosure and does not pass through the sound-sensing structure. The second path passes only through the first enclosure and therefore is a low-impedance path that is used to direct the major air flows from the first port (outlet) to the second port (inlet) with less residual turbulences picked up by the sensing element in the directional microphone. The first, second, third and fourth ports are protected against unwanted particulate matters by using protection layers.

The disclosed solution, as shown in FIG. 9, is suitable because it can leverage the already existing first and second ports of the existing directional mies and add a second low-impedance path through the third and fourth protected ports. The additional low-impedance path (relief channel) can be optimized so that the direct air flow passes through the relief channel, and the acoustic signals (e.g., within the frequency range of 20 Hz to 20 kHz) are directed through the directional microphone sound-sensing structure.

FIG. 10 is a schematic diagram illustrating a packaging structure of a directional microphone, according to certain aspects of the disclosure. The packaging structure of the directional microphone of FIG. 10 is similar to the structure of FIG. 9, except for the packaging structure being enclosed by a product enclosure that provides a single input port and a single output port. The air flowing into the second and fourth ports pass through the single input port, and the air flowing out of the first and third ports pass through the single output port, as shown in FIG. 10.

FIG. 11 is a schematic diagram illustrating a simplified model of a packaging structure of a traditional directional microphone for simulation, as discussed herein. The simplified geometry of the traditional directional microphone of FIG. 7, as shown in FIG. 11, depicts the inlet and outlet ports and a single path, and the air flow which enters from the inlet port and exits from the output ports. This simplified geometry can be used as a model of the traditional directional microphone for a computational fluid dynamics (CPD) simulation of the air flows to study the pressure and flow velocity.

The directional microphone of the subject technology, as shown in FIG. 11, includes a second path within the product structure. The first path is a high-impedance path while the second path passes only through the product enclosure and therefore is a low-impedance path. The second path is a direct path through the first port and the second port of the first enclosure that does not pass through the sound-sensing structure. The second path is used to direct the major air flows from the first port (inlet) to the second port (outlet) with less residual turbulences picked up by the sensing element in the directional microphone.

FIG. 12 is a schematic diagram illustrating a simplified model of a packaging structure of a directional microphone for simulation, according to certain aspects of the disclosure. The directional microphone of the subject technology, as shown in FIG. 9, includes a second path within the product structure. The first path is a high-impedance path while the second path passes only through the product enclosure and therefore is a low-impedance path. The second path is a direct path through the first port and the second port of the first enclosure that does not pass through the sound-sensing structure. The second path is used to direct the major air flows from the inlet port to the outlet port with less residual turbulences picked up by the sensing element in the directional mic.

The simplified geometry of the directional microphone of FIG. 9 is shown in FIG. 12, which depicts the inlet and outlet ports and the first and second paths. The air flow from both paths enters from the single input port and exits from the single output port of the enclosure. This simplified geometry can be used as a model of the disclosed directional microphone for a CPD simulation of the air flows to study the pressure and flow velocity. The first path is a high-impedance path of FIG. 10, which is modeled by a sensing membrane to model the air flow resistance due to the sound-sensing structure of FIG. 10.

FIG. 13 is a schematic diagram illustrating example simulated flow velocities inside an existing and a disclosed directional microphone, according to certain aspects of the disclosure. The simulated flow velocity inside the existing directional microphone (old design), shown on the left-hand side of FIG. 13, depicts non-uniformity because of the high impedance due to the sound-sensing structure. This issue is solved by the addition of the low-impedance path of the disclosed directional microphone (new design), as seen from the right-hand side portion of FIG. 13, which indicates uniform flow through both the low-impedance and high-impedance paths.

FIG. 14 is a schematic diagram illustrating example simulated pressures inside an existing and a disclosed directional microphone, according to certain aspects of the disclosure.

The simulated pressure inside the existing directional microphone (old design), shown on the left-hand side of FIG. 14, depicts non-uniformity because of the high impedance due to the sound-sensing structure, which causes high pressure buildup in the air flow before reaching the membrane that simulated the sound-sensing structure. The high-pressure build up issue is solved by the addition of the low-impedance path of the disclosed directional microphone (new design), as seen from the right-hand side portion of FIG. 14, which indicates uniform pressure through both the low-impedance and high-impedance paths. The simulation result also reveals a 32 dB improvement of the pressure in the high-impedance path of the disclosed directional microphone (new design) as compared to the existing directional microphone (old design).

FIG. 15 shows charts illustrating example simulated frequency responses and differences of a directional microphone of the subject technology. Plots shown in the top portion of FIG. 15 depict the frequency response at different sources. The broken lines correspond to the disclosed design and the solid lines correspond to the traditional designs. Results for source angles of zero degrees, 30 degrees and 60 degrees are shown, as described in the legends. The frequency response at 60 degrees and 30 degrees appear to be flatter than for 0 degrees.

Plots shown in the bottom portion of FIG. 15 depict the frequency response associated with delta at different sources. The delta for the source angles 30 and 60 degrees show a 6 dB sensitivity drop. The data indicates that optimization for improved wind performance and less impacted acoustic performance is achievable.

FIG. 16 shows a chart illustrating an example simulated directivity of a directional microphone of the subject technology. Based on the information provided by the legends of the chart, the directivity plots show that improvement in directivity is observed for the lower frequencies, e.g., 100 Hz and 1 kHz, and the improvement is more pronounced for the disclosed (new) design as compared to the traditional (old) design.

FIG. 17 is a schematic diagram illustrating a packaging structure of another embodiment of a directional microphone, according to certain aspects of the disclosure. The packaging structure shown in FIG. 17 corresponds to a different embodiment as compared to FIG. 9. The difference between this embodiment and the one shown in FIG. 9 is that for the second embodiment, the third port, which is an outlet port for the low-impedance path, is provided on the side of the first enclosure.

FIG. 18 is a schematic diagram illustrating a packaging structure of another embodiment of a directional microphone, according to certain aspects of the disclosure. The packaging structure shown in FIG. 18 corresponds to a different embodiment as compared to FIG. 10. The difference between this embodiment and the one shown in FIG. 10 is that for the second embodiment, the third port, which is an outlet port for the low-impedance path, is provided on the side of the first enclosure. However, in the product enclosure, the single input and outlet ports of the product enclosure are similar to the single input and outlet ports of the product enclosure of the packaging structure of FIG. 10.

In conclusion, the disclosed subject technology presents a method of reducing pressure and improving air flow through the sound-sensing structure of a directional microphone by introducing a low-impedance path. The low-impedance path is used to direct the major air flows from the first port (inlet) to the second port (outlet) with less residual turbulences picked up by the sensing element in the directional mic. The disclosed solution is efficient because it can leverage the already existing first and second ports of the external enclosure of the existing directional microphones and add a second low-impedance path without adding more external openings.

Directional Microphone Integration with Improved Performance Against Air Flows

### Technical Field

The present disclosure generally relates to sensor devices, and more particularly, to a directional microphone integration with improved performance against air flows.

### Background

A directional microphone is a type of microphone that primarily picks up sounds from a specific direction. Unlike omnidirectional microphones, which capture sound from all directions, directional mies are more focused and sensitive in one or more specific directions. These microphones are commonly used in various audio recording scenarios, such as podcasts, voiceovers, and video production. A directional microphone is an excellent choice for superior isolation and reduced interference from surrounding noise. Directional microphones receive attentions with its good performance targeting at certain spatial angles and therefore performance beamforming functions on its own single sensor integration, which saves cost and eases integration.

However, for a typical directional microphone design, both sides of the sensing membrane are exposed to the external environment, and it is more susceptible to wind noise and maybe plosive sound. Historically, for most directional microphones, some wind treatment such as a wind socket, a heavy acoustic resistive mesh or some other wind treatment measure would be required.

### SUMMARY

The subject disclosure is directed to a directional microphone integration with improved performance against air flows that leverages a second low-impedance path to direct the major air flows to and from the inlet to the outlet with less residual turbulences picked up by the sensing element in directional mics.

### BRIEF DESCRIPTION OF THE DRAWINGS

To easily identify the discussion of any particular element or act, the most significant digit or digits in a reference number refer to the figure number in which that element is first introduced.

FIG. 19 is a schematic diagram illustrating an example of a structure of a directional microphone, as discussed herein.

FIG. 20 is a schematic diagram illustrating an example structure of a directional microphone with an enclosure, as discussed herein.

FIG. 21 is a schematic diagram illustrating an example structure of a directional microphone with a second path, according to certain aspects of the disclosure.

FIG. 22 is a schematic diagram illustrating an example simplified geometry of the directional microphone of FIG. 21 for simulation, according to certain aspects of the disclosure.

FIG. 23 is a schematic diagram illustrating an example structure of a directional microphone with a second path, according to certain aspects of the disclosure.

FIG. 24 is a schematic diagram illustrating an example of a simplified geometry of the directional microphone of FIG. 23 for simulation, according to certain aspects of the disclosure.

FIG. 25 is a schematic diagram illustrating example simulated flow velocities inside an existing and a disclosed directional microphone, according to certain aspects of the disclosure.

FIG. 26 is a schematic diagram illustrating example simulated pressures inside an existing and a disclosed directional microphone, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to a directional microphone integration with improved performance against air flows. The disclosed solution uses a second low-impedance path (channel) to direct the major air flows to and from the inlet to the outlet with less residual turbulences picked up by the sensing element in directional mies. The disclosed solution is suitable as the existing directional mies use dual-port integration, which can be leveraged by a second low-impedance path without adding more external openings to the enclosure structure. The low-impedance (relief) channel of the disclosed solution can be optimized so that the direct air flow goes from the relief channel, and the acoustic signals (e.g., within the frequency range of 20 Hz to 20 kHz) are directed through the directional mic sensor.

The disclosed solution improves the voice-capture quality in windy environments for directional microphones and reduces the cost because less microphones are needed compared to normal microphone array systems. The subject technology solves the pain point in the industry where directional microphones with unique acoustic performance are desired but are less popular due to the wind noise issues. The disclosed solution is especially important for adding the unique wind performance feature to mixed reality (MR) devices and smart glasses for major outdoor activities.

In some implementations, an apparatus of the subject technology includes a first airflow path through a sound-sensing structure and the second low-impedance airflow path. The first and the second airflow paths pass through a first port and a second port.

In one or more implementations, the second airflow path is configured to be a direct path through an enclosure of the apparatus.

In one or more implementations, the second airflow path is configured to direct major air flows from the first port to the second port with less residual turbulences.

In some implementations, the second airflow path is created on one of two sides of the first airflow path.

In one or more implementations, the second airflow path is configured to improve the pressure within the first airflow path by about 12 dB.

In some implementations, the second airflow path is configured to improve the flow velocity uniformity within the first path.

In one or more implementations, the apparatus comprises a directional microphone.

Turning now to the figures, FIG. 19 is a schematic diagram illustrating an example structure of a directional microphone, as discussed herein. The directional microphone, as shown in FIG. 19, includes a first port and a second port. The first port is located in the substrate on which the sound-sensing structure and the support electronics are placed. The second port is located on a first enclosure across the first port and above the sound-sensing structure.

FIG. 20 is a schematic diagram illustrating an example structure of a directional microphone with an enclosure, as discussed herein. The directional microphone shown in FIG. 20 is structurally the same as the directional microphone of FIG. 19 within the first enclosure, except that in FIG. 20, a second enclosure (product enclosure) is added by using sealing stack components around the first and the second port of the first enclosure.

FIG. 21 is a schematic diagram illustrating an example structure of a directional microphone with a second path, according to certain aspects of the disclosure. The directional microphone of the subject technology, as shown in FIG. 21, includes a second path within the product structure. The first path is a high-impedance path because of the resistance due to the sound-sensing structure being on the way of the air flow. The second path is a direct path through the first port and the second port of the first enclosure and does not pass through the sound-sensing structure. The second path passes only through the product enclosure and therefore is a low-impedance path that is used to direct the major air flows from the first port (inlet) to the second port (outlet) with less residual turbulences picked up by the sensing element in the directional mic. The disclosed solution, as shown in FIG. 21, is suitable because it can leverage the already existing first and second ports of the existing directional mies and add a second low-impedance path without adding more external openings. The additional low-impedance path (relief channel) can be optimized so that the direct air flow goes from the relief channel, and the acoustic signals (e.g., within the frequency range of 20 Hz to 20 kHz) are directed through the directional mic sound-sensing structure.

FIG. 22 is a schematic diagram illustrating an example of a simplified geometry of the directional microphone of FIG. 21 for simulation, according to certain aspects of the disclosure. The simplified geometry of the directional microphone of FIG. 21, as shown in FIG. 22, depicts the inlet and outlet ports and the first and second paths, and the air flow which enters from the inlet port and exits from the output ports. This simplified geometry can be used as a model of the disclosed directional mic for a computational fluid dynamics (CPD) simulation of the air flows to study the pressure and flow velocity. The first path is a high-impedance path of FIG. 21, which is modeled by a sensing membrane to model the air flow resistance due to the sound-sensing structure of FIG. 21.

FIG. 23 is a schematic diagram illustrating an example structure of a directional microphone with a second path, according to certain aspects of the disclosure. The directional microphone of the subject technology, as shown in FIG. 23, includes a second path within the product structure. The first path is a high-impedance path while the second path passes only through the product enclosure and therefore is a low-impedance path. The second path is a direct path through the first port and the second port of the first enclosure that does not pass through the sound-sensing structure. The second path is used to direct the major air flows from the first port (inlet) to the second port (outlet) with less residual turbulences picked up by the sensing element in the directional mic.

FIG. 24 is a schematic diagram illustrating an example simplified geometry of the directional microphone of FIG. 23 for simulation, according to certain aspects of the disclosure. The simplified geometry of the directional microphone of FIG. 23 is shown in FIG. 24, which depicts the inlet and outlet ports and the first and second paths. The air flow from both paths enters from the inlet port and exits from the output ports. This simplified geometry can be used as a model of the disclosed directional mic for a CPD simulation of the air flows to study the pressure and flow velocity. The first path is a high-impedance path of FIG. 22, which is modeled by a sensing membrane to model the air flow resistance due to the sound-sensing structure of FIG. 23.

FIG. 25 is a schematic diagram illustrating example simulated flow velocities inside an existing and a disclosed directional microphone, according to certain aspects of the disclosure. The simulated flow velocity inside the existing directional microphone (old design) shows non-uniformity because of the high impedance due to the sound-sensing structure. This issue is solved by addition of the low-impedance path of the disclosed directional microphone (new design), as seen from FIG. 25, which indicates uniform flow through both the low-impedance and high-impedance paths.

FIG. 26 is a schematic diagram illustrating example simulated pressures inside an existing and a disclosed directional microphone, according to certain aspects of the disclosure. The simulated pressure inside the existing directional microphone (old design) shows non-uniformity because of the high impedance due to the sound-sensing structure, which causes high pressure buildup in the air flow before reaching the membrane that simulated the sound-sensing structure. The high-pressure build up issue is solved by the addition of the low-impedance path of the disclosed directional microphone (new design), as seen from FIG. 8, which indicates uniform pressure through both the low-impedance and high-impedance paths. The simulation result also reveals a 12 dB improvement of the pressure in the high-impedance path of the disclosed directional microphone (new design) as compared to the existing directional microphone (old design).

In conclusion, the disclosed subject technology presents a method of reducing pressure and improving air flow through the sound-sensing structure of a directional microphone by introducing a low-impedance path. The low-impedance path is used to direct the major air flows from the first port (inlet) to the second port (outlet) with less residual turbulences picked up by the sensing element in the directional mic. The disclosed solution is efficient because it can leverage the already existing first and second ports of the existing directional mies and add a second low-impedance path without adding more external openings.

### An Approach for Expressing Rich Personalized Information in a Limited Notification Message

### Brief Description of the Drawings

The accompanying drawings illustrate a number of exemplary embodiments and are a part of the specification. Together with the following description, these drawings demonstrate and explain various principles of the present disclosure.

FIG. 27 is an illustration of an exemplary personalized notification message, according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### Detailed Description of Exemplary Embodiments

A social-networking application may enable its users (such as persons or organizations) to interact with it and with each other through it. The profile of a user of a social-networking application may include demographic information, communication-channel information, and information on personal interests of the user. The social-networking system may also, with input from a user, create and store a record of relationships and provide services (e.g., wall posts, photo-sharing, event organization, messaging, games, or advertisements) to facilitate social interaction between or among users. Social-networking applications may also leverage a notification-based feature to push important news and/or events to users associated with the above-mentioned services. However, traditional notifications suffer from a variety of drawbacks, including displaying or providing limited information that may be unclear and/or irrelevant to the user.

As described herein, instead of presenting static, limited information in a notification message that may be irrelevant to the user, the present disclosure describes a unique approach to generating, using a machine-learning-based summarization model, concise notification messages that are personalized and tailored to a user's interests.

As shown in FIG. 27, notification message 2700 may include personalized information 2702 that is customized for a user of a social media network. The term “social media network” may generally refer to a digital platform that enables users to create and share content or participate in social networking. The term “notification message” may generally refer to an alert that informs users about new activities or interactions corresponding to posts and/or stories on a social media network.

As illustrated in FIG. 27, instead of including an entire message corresponding to a post and/or story, notification message 2700 may include personalized information 2702 that is generated by a machine-learning-based summarization model based on an identified interest of the user. The term “machine-learning-based summarization model” may generally refer to a machine learning technique that is trained on large data sets of test examples to learn patterns and structures to distill information, such as user's interactions and engagement behavior on a social media network. For example, by analyzing all of a user's interactions with posts and/or stories on a social media network, the machine-learning-based summarization model may identify topics that are of interest to the user. Upon identifying these topics of interest, the machine-learning-based summarization model may generate custom, personalized notifications for the user for new social media events (e.g., events associated with posts, stories, etc.), potentially increasing the chances that the user while interact with the notification and engage with the event.

In on example, this approach to personalizing information for the user may include identifying, using a machine-learning-based summarization model, interests of a user of a social media network, and extracting, using the machine-learning-based summarization model, information from a post to the social media network that aligns with the user's interests. Consequently, a personalized notification message for the user is generated using the machine-learning-based summarization model, based on the information extracted from the post that aligns with the user's interests.

As detailed above, because of the concise and personalized nature of the resulting notification message (which corresponds to the user's specific interests), the disclosed systems and methods may help increase user engagement with, and retention, to certain products, stories, and/or posts.

### Artificial-Reality Environments

### Brief Description of the Drawings

The accompanying drawings illustrate a number of exemplary embodiments and are a part of the specification. Together with the following description, these drawings demonstrate and explain various principles of the present disclosure.

FIG. 28 is an illustration of an example artificial-reality system according to some embodiments of this disclosure.

FIG. 29 is an illustration of an example artificial-reality system with a handheld device according to some embodiments of this disclosure.

FIG. 30A is an illustration of example user interactions within an artificial-reality system according to some embodiments of this disclosure.

FIG. 30B is an illustration of example user interactions within an artificial-reality system according to some embodiments of this disclosure.

FIG. 31A is an illustration of example user interactions within an artificial-reality system according to some embodiments of this disclosure.

FIG. 31B is an illustration of example user interactions within an artificial-reality system according to some embodiments of this disclosure.

FIG. 32 is an illustration of an example wrist-wearable device of an artificial-reality system according to some embodiments of this disclosure.

FIG. 33 is an illustration of an example wearable artificial-reality system according to some embodiments of this disclosure.

FIG. 34 is an illustration of an example augmented-reality system according to some embodiments of this disclosure.

FIG. 35A is an illustration of an example virtual-reality system according to some embodiments of this disclosure.

FIG. 35B is an illustration of another perspective of the virtual-reality systems shown in FIG. 35A.

FIG. 36 is a block diagram showing system components of example artificial- and virtual-reality systems.

FIG. 37A is an illustration of an example intermediary processing device according to embodiments of this disclosure.

FIG. 37B is a perspective view of the intermediary processing device shown in FIG. 37A.

FIG. 38 is a block diagram showing example components of the intermediary processing device illustrated in FIGS. 37A and 37B.

FIG. 39A is front view of an example haptic feedback device according to embodiments of this disclosure.

FIG. 39B is a back view of the example haptic feedback device shown in FIG.

FIG. 39A according to embodiments of this disclosure.

FIG. 40 is a block diagram of example components of a haptic feedback device according to embodiments of this disclosure.

FIG. 41 an illustration of an example system that incorporates an eye-tracking subsystem capable of tracking a user's eye(s).

FIG. 42 is a more detailed illustration of various aspects of the eye-tracking subsystem illustrated in FIG. 41.

FIG. 43 is an illustration of an example fluidic control system that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### Detailed Description of Exemplary Embodiments

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

AR systems may be implemented in a variety of different form factors and configurations. Some AR systems may be designed to work without near-eye displays (NEDs). Other AR systems may include a NED that also provides visibility into the real world (such as, e.g., augmented-reality system 3400 in FIG. 34) or that visually immerses a user in an artificial reality (such as, e.g., virtual-reality system 3500 in FIGS. 35A and 35B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

FIGS. 28-31B illustrate example artificial-reality (AR) systems in accordance with some embodiments. FIG. 28 shows a first AR system 2800 and first example user interactions using a wrist-wearable device 2802, a head-wearable device (e.g., AR glasses 3400), and/or a handheld intermediary processing device (HIPD) 2806. FIG. 29 shows a second AR system 2900 and second example user interactions using a wrist-wearable device 2902, AR glasses 2904, and/or an HIPD 2906. FIGS. 30A and 30B show a third AR system 3000 and third example user 3008 interactions using a wrist-wearable device 3002, a head-wearable device (e.g., VR headset 3050), and/or an HIPD 3006. FIGS. 31A and 31B show a fourth AR system 3100 and fourth example user 3108 interactions using a wrist-wearable device 3130, VR headset 3120, and/or a haptic device 3160 (e.g., wearable gloves).

A wrist-wearable device 3200, which can be used for wrist-wearable device 2802, 2902, 3002, 3130, and one or more of its components, are described below in reference to FIGS. 32 and 33; head-wearable devices 3400 and 3500, which can respectively be used for AR glasses 2804, 2904 or VR headset 3050, 3120, and their one or more components are described below in reference to FIGS. 34-36.

Referring to FIG. 28, wrist-wearable device 2802, AR glasses 2804, and/or HIPD 2806 can communicatively couple via a network 2825 (e.g., cellular, near field, Wi-Fi, personal area network, wireless LAN, etc.). Additionally, wrist-wearable device 2802, AR glasses 2804, and/or HIPD 2806 can also communicatively couple with one or more servers 2830, computers 2840 (e.g., laptops, computers, etc.), mobile devices 2850 (e.g., smartphones, tablets, etc.), and/or other electronic devices via network 2825 (e.g., cellular, near field, Wi-Fi, personal area network, wireless LAN, etc.).

In FIG. 28, a user 2808 is shown wearing wrist-wearable device 2802 and AR glasses 2804 and having HIPD 2806 on their desk. The wrist-wearable device 2802, AR glasses 2804, and HIPD 2806 facilitate user interaction with an AR environment. In particular, as shown by first AR system 2800, wrist-wearable device 2802, AR glasses 2804, and/or HIPD 2806 cause presentation of one or more avatars 2810, digital representations of contacts 2812, and virtual objects 2814. As discussed below, user 2808 can interact with one or more avatars 2810, digital representations of contacts 2812, and virtual objects 2814 via wrist-wearable device 2802, AR glasses 2804, and/or HIPD 2806.

User 2808 can use any of wrist-wearable device 2802, AR glasses 2804, and/or HIPD 2806 to provide user inputs. For example, user 2808 can perform one or more hand gestures that are detected by wrist-wearable device 2802 (e.g., using one or more EMG sensors and/or IMUs, described below in reference to FIGS. 32 and 33) and/or AR glasses 2804 (e.g., using one or more image sensor or camera, described below in reference to FIGS. 34-10) to provide a user input. Alternatively, or additionally, user 2808 can provide a user input via one or more touch surfaces of wrist-wearable device 2802, AR glasses 2804, HIPD 2806, and/or voice commands captured by a microphone of wrist-wearable device 2802, AR glasses 2804, and/or HIPD 2806. In some embodiments, wrist-wearable device 2802, AR glasses 2804, and/or HIPD 2806 include a digital assistant to help user 2808 in providing a user input (e.g., completing a sequence of operations, suggesting different operations or commands, providing reminders, confirming a command, etc.). In some embodiments, user 2808 can provide a user input via one or more facial gestures and/or facial expressions. For example, cameras of wrist-wearable device 2802, AR glasses 2804, and/or HIPD 2806 can track eyes of user 2808 for navigating a user interface.

Wrist-wearable device 2802, AR glasses 2804, and/or HIPD 2806 can operate alone or in conjunction to allow user 2808 to interact with the AR environment. In some embodiments, HIPD 2806 is configured to operate as a central hub or control center for the wrist-wearable device 2802, AR glasses 2804, and/or another communicatively coupled device. For example, user 2808 can provide an input to interact with the AR environment at any of wrist-wearable device 2802, AR glasses 2804, and/or HIPD 2806, and HIPD 2806 can identify one or more back-end and front-end tasks to cause the performance of the requested interaction and distribute instructions to cause the performance of the one or more back-end and front-end tasks at wrist-wearable device 2802, AR glasses 2804, and/or HIPD 2806. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. 37-38, HIPD 2806 can perform the back-end tasks and provide wrist-wearable device 2802 and/or AR glasses 2804 operational data corresponding to the performed back-end tasks such that wrist-wearable device 2802 and/or AR glasses 2804 can perform the front-end tasks. In this way, HIPD 2806, which has more computational resources and greater thermal headroom than wrist-wearable device 2802 and/or AR glasses 2804, performs computationally intensive tasks and reduces the computer resource utilization and/or power usage of wrist-wearable device 2802 and/or AR glasses 2804.

In the example shown by first AR system 2800, HIPD 2806 identifies one or more back-end tasks and front-end tasks associated with a user request to initiate an AR video call with one or more other users (represented by avatar 2810 and the digital representation of contact 2812) and distributes instructions to cause the performance of the one or more back-end tasks and front-end tasks. In particular, HIPD 2806 performs back-end tasks for processing and/or rendering image data (and other data) associated with the AR video call and provides operational data associated with the performed back-end tasks to AR glasses 2804 such that the AR glasses 2804 perform front-end tasks for presenting the AR video call (e.g., presenting avatar 2810 and digital representation of contact 2812).

In some embodiments, HIPD 2806 can operate as a focal or anchor point for causing the presentation of information. This allows user 2808 to be generally aware of where information is presented. For example, as shown in first AR system 2800, avatar 2810 and the digital representation of contact 2812 are presented above HIPD 2806. In particular, HIPD 2806 and AR glasses 2804 operate in conjunction to determine a location for presenting avatar 2810 and the digital representation of contact 2812. In some embodiments, information can be presented a predetermined distance from HIPD 2806 (e.g., within 5 meters). For example, as shown in first AR system 2800, virtual object 2814 is presented on the desk some distance from HIPD 2806. Similar to the above example, HIPD 2806 and AR glasses 2804 can operate in conjunction to determine a location for presenting virtual object 2814. Alternatively, in some embodiments, presentation of information is not bound by HIPD 2806. More specifically, avatar 2810, digital representation of contact 2812, and virtual object 2814 do not have to be presented within a predetermined distance of HIPD 2806.

User inputs provided at wrist-wearable device 2802, AR glasses 2804, and/or HIPD 2806 are coordinated such that the user can use any device to initiate, continue, and/or complete an operation. For example, user 2808 can provide a user input to AR glasses 2804 to cause AR glasses 2804 to present virtual object 2814 and, while virtual object 2814 is presented by AR glasses 2804, user 2808 can provide one or more hand gestures via wrist-wearable device 2802 to interact and/or manipulate virtual object 2814.

FIG. 29 shows a user 2908 wearing a wrist-wearable device 2902 and AR glasses 2904, and holding an HIPD 2906. In second AR system 2900, the wrist-wearable device 2902, AR glasses 2904, and/or HIPD 2906 are used to receive and/or provide one or more messages to a contact of user 2908. In particular, wrist-wearable device 2902, AR glasses 2904, and/or HIPD 2906 detect and coordinate one or more user inputs to initiate a messaging application and prepare a response to a received message via the messaging application.

In some embodiments, user 2908 initiates, via a user input, an application on wrist-wearable device 2902, AR glasses 2904, and/or HIPD 2906 that causes the application to initiate on at least one device. For example, in second AR system 2900, user 2908 performs a hand gesture associated with a command for initiating a messaging application (represented by messaging user interface 2916), wrist-wearable device 2902 detects the hand gesture and, based on a determination that user 2908 is wearing AR glasses 2904, causes AR glasses 2904 to present a messaging user interface 2916 of the messaging application. AR glasses 2904 can present messaging user interface 2916 to user 2908 via its display (e.g., as shown by a field of view 2918 of user 2908). In some embodiments, the application is initiated and executed on the device (e.g., wrist-wearable device 2902, AR glasses 2904, and/or HIPD 2906) that detects the user input to initiate the application, and the device provides another device operational data to cause the presentation of the messaging application. For example, wrist-wearable device 2902 can detect the user input to initiate a messaging application, initiate and run the messaging application, and provide operational data to AR glasses 2904 and/or HIPD 2906 to cause presentation of the messaging application. Alternatively, the application can be initiated and executed at a device other than the device that detected the user input. For example, wrist-wearable device 2902 can detect the hand gesture associated with initiating the messaging application and cause HIPD 2906 to run the messaging application and coordinate the presentation of the messaging application.

Further, user 2908 can provide a user input provided at wrist-wearable device 2902, AR glasses 2904, and/or HIPD 2906 to continue and/or complete an operation initiated at another device. For example, after initiating the messaging application via wrist-wearable device 2902 and while AR glasses 2904 present messaging user interface 2916, user 2908 can provide an input at HIPD 2906 to prepare a response (e.g., shown by the swipe gesture performed on HIPD 2906). Gestures performed by user 2908 on HIPD 2906 can be provided and/or displayed on another device. For example, a swipe gestured performed on HIPD 2906 is displayed on a virtual keyboard of messaging user interface 2916 displayed by AR glasses 2904.

In some embodiments, wrist-wearable device 2902, AR glasses 2904, HIPD 2906, and/or any other communicatively coupled device can present one or more notifications to user 2908. The notification can be an indication of a new message, an incoming call, an application update, a status update, etc. User 2908 can select the notification via wrist-wearable device 2902, AR glasses 2904, and/or HIPD 2906 and can cause presentation of an application or operation associated with the notification on at least one device. For example, user 2908 can receive a notification that a message was received at wrist-wearable device 2902, AR glasses 2904, HIPD 2906, and/or any other communicatively coupled device and can then provide a user input at wrist-wearable device 2902, AR glasses 2904, and/or HIPD 2906 to review the notification, and the device detecting the user input can cause an application associated with the notification to be initiated and/or presented at wrist-wearable device 2902, AR glasses 2904, and/or HIPD 2906.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 2904 can present to user 2908 game application data, and HIPD 2906 can be used as a controller to provide inputs to the game. Similarly, user 2908 can use wrist-wearable device 2902 to initiate a camera of AR glasses 2904, and user 308 can use wrist-wearable device 2902, AR glasses 2904, and/or HIPD 2906 to manipulate the image capture (e.g., zoom in or out, apply filters, etc.) and capture image data.

Users may interact with the devices disclosed herein in a variety of ways. For example, as shown in FIGS. 30A and 30B, a user 3008 may interact with an AR system 3000 by donning a VR headset 3050 while holding HIPD 3006 and wearing wrist-wearable device 3002. In this example, AR system 3000 may enable a user to interact with a game 3010 by swiping their arm. One or more of VR headset 3050, HIPD 3006, and wrist-wearable device 3002 may detect this gesture and, in response, may display a sword strike in game 3010. Similarly, in FIGS. 31A and 31B, a user 3108 may interact with an AR system 3100 by donning a VR headset 3120 while wearing haptic device 3160 and wrist-wearable device 3130. In this example, AR system 3100 may enable a user to interact with a game 3110 by swiping their arm. One or more of VR headset 3120, haptic device 3160, and wrist-wearable device 3130 may detect this gesture and, in response, may display a spell being cast in game 3010.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogra sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 3402.15.4, Wi-Fi, ZigBee, 6LOWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 32 and 33 illustrate an example wrist-wearable device 3200 and an example computer system 3300, in accordance with some embodiments. Wrist-wearable device 3200 is an instance of wearable device 2802 described in FIG. 28 herein, such that the wearable device 2802 should be understood to have the features of the wrist-wearable device 3200 and vice versa. FIG. 33 illustrates components of the wrist-wearable device 3200, which can be used individually or in combination, including combinations that include other electronic devices and/or electronic components.

FIG. 32 shows a wearable band 3210 and a watch body 3220 (or capsule) being coupled, as discussed below, to form wrist-wearable device 3200. Wrist-wearable device 3200 can perform various functions and/or operations associated with navigating through user interfaces and selectively opening applications as well as the functions and/or operations described above with reference to FIGS. 28-31B.

As will be described in more detail below, operations executed by wrist-wearable device 3200 can include (i) presenting content to a user (e.g., displaying visual content via a display 3205), (ii) detecting (e.g., sensing) user input (e.g., sensing a touch on peripheral button 3223 and/or at a touch screen of the display 3205, a hand gesture detected by sensors (e.g., biopotential sensors)), (iii) sensing biometric data (e.g., neuromuscular signals, heart rate, temperature, sleep, etc.) via one or more sensors 3213, messaging (e.g., text, speech, video, etc.); image capture via one or more imaging devices or cameras 3225, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 3220, independently in wearable band 3210, and/or via an electronic communication between watch body 3220 and wearable band 3210. In some embodiments, functions can be executed on wrist-wearable device 3200 while an AR environment is being presented (e.g., via one of AR systems 2800 to 3100). The wearable devices described herein can also be used with other types of AR environments.

Wearable band 3210 can be configured to be worn by a user such that an inner surface of a wearable structure 3211 of wearable band 3210 is in contact with the user's skin. In this example, when worn by a user, sensors 3213 may contact the user's skin. In some examples, one or more of sensors 3213 can sense biometric data such as a user's heart rate, a saturated oxygen level, temperature, sweat level, neuromuscular signals, or a combination thereof. One or more of sensors 3213 can also sense data about a user's environment including a user's motion, altitude, location, orientation, gait, acceleration, position, or a combination thereof. In some embodiment, one or more of sensors 3213 can be configured to track a position and/or motion of wearable band 3210. One or more of sensors 3213 can include any of the sensors defined above and/or discussed below with respect to FIG. 32.

One or more of sensors 3213 can be distributed on an inside and/or an outside surface of wearable band 3210. In some embodiments, one or more of sensors 3213 are uniformly spaced along wearable band 3210. Alternatively, in some embodiments, one or more of sensors 3213 are positioned at distinct points along wearable band 3210. As shown in FIG. 32, one or more of sensors 3213 can be the same or distinct. For example, in some embodiments, one or more of sensors 3213 can be shaped as a pill (e.g., sensor 3213a), an oval, a circle a square, an oblong (e.g., sensor 3213c) and/or any other shape that maintains contact with the user's skin (e.g., such that neuromuscular signal and/or other biometric data can be accurately measured at the user's skin). In some embodiments, one or more sensors of 3213 are aligned to form pairs of sensors (e.g., for sensing neuromuscular signals based on differential sensing within each respective sensor). For example, sensor 3213b may be aligned with an adjacent sensor to form sensor pair 3214a and sensor 3213d may be aligned with an adjacent sensor to form sensor pair 3214b. In some embodiments, wearable band 3210 does not have a sensor pair. Alternatively, in some embodiments, wearable band 3210 has a predetermined number of sensor pairs (one pair of sensors, three pairs of sensors, four pairs of sensors, six pairs of sensors, sixteen pairs of sensors, etc.).

Wearable band 3210 can include any suitable number of sensors 3213. In some embodiments, the number and arrangement of sensors 3213 depends on the particular application for which wearable band 3210 is used. For instance, wearable band 3210 can be configured as an armband, wristband, or chest-band that include a plurality of sensors 3213 with different number of sensors 3213, a variety of types of individual sensors with the plurality of sensors 3213, and different arrangements for each use case, such as medical use cases as compared to gaming or general day-to-day use cases.

In accordance with some embodiments, wearable band 3210 further includes an electrical ground electrode and a shielding electrode. The electrical ground and shielding electrodes, like the sensors 3213, can be distributed on the inside surface of the wearable band 3210 such that they contact a portion of the user's skin. For example, the electrical ground and shielding electrodes can be at an inside surface of a coupling mechanism 3216 or an inside surface of a wearable structure 3211. The electrical ground and shielding electrodes can be formed and/or use the same components as sensors 3213. In some embodiments, wearable band 3210 includes more than one electrical ground electrode and more than one shielding electrode.

Sensors 3213 can be formed as part of wearable structure 3211 of wearable band 3210. In some embodiments, sensors 3213 are flush or substantially flush with wearable structure 3211 such that they do not extend beyond the surface of wearable structure 3211. While flush with wearable structure 3211, sensors 3213 are still configured to contact the user's skin (e.g., via a skin-contacting surface). Alternatively, in some embodiments, sensors 3213 extend beyond wearable structure 3211 a predetermined distance (e.g., 0.1-2 mm) to make contact and depress into the user's skin. In some embodiment, sensors 3213 are coupled to an actuator (not shown) configured to adjust an extension height (e.g., a distance from the surface of wearable structure 3211) of sensors 3213 such that sensors 3213 make contact and depress into the user's skin. In some embodiments, the actuators adjust the extension height between 0.01 mm-1.2 mm. This may allow a the user to customize the positioning of sensors 3213 to improve the overall comfort of the wearable band 3210 when worn while still allowing sensors 3213 to contact the user's skin. In some embodiments, sensors 3213 are indistinguishable from wearable structure 3211 when worn by the user.

Wearable structure 3211 can be formed of an elastic material, elastomers, etc., configured to be stretched and fitted to be worn by the user. In some embodiments, wearable structure 3211 is a textile or woven fabric. As described above, sensors 3213 can be formed as part of a wearable structure 3211. For example, sensors 3213 can be molded into the wearable structure 3211, be integrated into a woven fabric (e.g., sensors 3213 can be sewn into the fabric and mimic the pliability of fabric and can and/or be constructed from a series woven strands of fabric).

Wearable structure 3211 can include flexible electronic connectors that interconnect sensors 3213, the electronic circuitry, and/or other electronic components (described below in reference to FIG. 33) that are enclosed in wearable band 3210. In some embodiments, the flexible electronic connectors are configured to interconnect sensors 3213, the electronic circuitry, and/or other electronic components of wearable band 3210 with respective sensors and/or other electronic components of another electronic device (e.g., watch body 3220). The flexible electronic connectors are configured to move with wearable structure 3211 such that the user adjustment to wearable structure 3211 (e.g., resizing, pulling, folding, etc.) does not stress or strain the electrical coupling of components of wearable band 3210.

As described above, wearable band 3210 is configured to be worn by a user. In particular, wearable band 3210 can be shaped or otherwise manipulated to be worn by a user. For example, wearable band 3210 can be shaped to have a substantially circular shape such that it can be configured to be worn on the user's lower arm or wrist. Alternatively, wearable band 3210 can be shaped to be worn on another body part of the user, such as the user's upper arm (e.g., around a bicep), forearm, chest, legs, etc. Wearable band 3210 can include a retaining mechanism 3212 (e.g., a buckle, a hook and loop fastener, etc.) for securing wearable band 3210 to the user's wrist or other body part. While wearable band 3210 is worn by the user, sensors 3213 sense data (referred to as sensor data) from the user's skin. In some examples, sensors 3213 of wearable band 3210 obtain (e.g., sense and record) neuromuscular signals.

The sensed data (e.g., sensed neuromuscular signals) can be used to detect and/or determine the user's intention to perform certain motor actions. In some examples, sensors 3213 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 3205 of wrist-wearable device 3200 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 3213 can be used to provide a user with an enhanced interaction with a physical object (e.g., devices communicatively coupled with wearable band 3210) and/or a virtual object in an artificial-reality application generated by an artificial-reality system (e.g., user interface objects presented on the display 3205, or another computing device (e.g., a smartphone)).

In some embodiments, wearable band 3210 includes one or more haptic devices 3346 (e.g., a vibratory haptic actuator) that are configured to provide haptic feedback (e.g., a cutaneous and/or kinesthetic sensation, etc.) to the user's skin. Sensors 3213 and/or haptic devices 3346 (shown in FIG. 33) can be configured to operate in conjunction with multiple applications including, without limitation, health monitoring, social media, games, and artificial reality (e.g., the applications associated with artificial reality).

Wearable band 3210 can also include coupling mechanism 3216 for detachably coupling a capsule (e.g., a computing unit) or watch body 3220 (via a coupling surface of the watch body 3220) to wearable band 3210. For example, a cradle or a shape of coupling mechanism 3216 can correspond to shape of watch body 3220 of wrist-wearable device 3200. In particular, coupling mechanism 3216 can be configured to receive a coupling surface proximate to the bottom side of watch body 3220 (e.g., a side opposite to a front side of watch body 3220 where display 3205 is located), such that a user can push watch body 3220 downward into coupling mechanism 3216 to attach watch body 3220 to coupling mechanism 3216. In some embodiments, coupling mechanism 3216 can be configured to receive a top side of the watch body 3220 (e.g., a side proximate to the front side of watch body 3220 where display 3205 is located) that is pushed upward into the cradle, as opposed to being pushed downward into coupling mechanism 3216. In some embodiments, coupling mechanism 3216 is an integrated component of wearable band 3210 such that wearable band 3210 and coupling mechanism 3216 are a single unitary structure. In some embodiments, coupling mechanism 3216 is a type of frame or shell that allows watch body 3220 coupling surface to be retained within or on wearable band 3210 coupling mechanism 3216 (e.g., a cradle, a tracker band, a support base, a clasp, etc.).

Coupling mechanism 3216 can allow for watch body 3220 to be detachably coupled to the wearable band 3210 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 3220 to wearable band 3210 and to decouple the watch body 3220 from the wearable band 3210. For example, a user can twist, slide, turn, push, pull, or rotate watch body 3220 relative to wearable band 3210, or a combination thereof, to attach watch body 3220 to wearable band 3210 and to detach watch body 3220 from wearable band 3210. Alternatively, as discussed below, in some embodiments, the watch body 3220 can be decoupled from the wearable band 3210 by actuation of a release mechanism 3229.

Wearable band 3210 can be coupled with watch body 3220 to increase the functionality of wearable band 3210 (e.g., converting wearable band 3210 into wrist-wearable device 3200, adding an additional computing unit and/or battery to increase computational resources and/or a battery life of wearable band 3210, adding additional sensors to improve sensed data, etc.). As described above, wearable band 3210 and coupling mechanism 3216 are configured to operate independently (e.g., execute functions independently) from watch body 3220. For example, coupling mechanism 3216 can include one or more sensors 3213 that contact a user's skin when wearable band 3210 is worn by the user, with or without watch body 3220 and can provide sensor data for determining control commands.

A user can detach watch body 3220 from wearable band 3210 to reduce the encumbrance of wrist-wearable device 3200 to the user. For embodiments in which watch body 3220 is removable, watch body 3220 can be referred to as a removable structure, such that in these embodiments wrist-wearable device 3200 includes a wearable portion (e.g., wearable band 3210) and a removable structure (e.g., watch body 3220).

Turning to watch body 3220, in some examples watch body 3220 can have a substantially rectangular or circular shape. Watch body 3220 is configured to be worn by the user on their wrist or on another body part. More specifically, watch body 3220 is sized to be easily carried by the user, attached on a portion of the user's clothing, and/or coupled to wearable band 3210 (forming the wrist-wearable device 3200). As described above, watch body 3220 can have a shape corresponding to coupling mechanism 3216 of wearable band 3210. In some embodiments, watch body 3220 includes a single release mechanism 3229 or multiple release mechanisms (e.g., two release mechanisms 3229 positioned on opposing sides of watch body 3220, such as spring-loaded buttons) for decoupling watch body 3220 from wearable band 3210. Release mechanism 3229 can include, without limitation, a button, a knob, a plunger, a handle, a lever, a fastener, a clasp, a dial, a latch, or a combination thereof.

A user can actuate release mechanism 3229 by pushing, turning, lifting, depressing, shifting, or performing other actions on release mechanism 3229. Actuation of release mechanism 3229 can release (e.g., decouple) watch body 3220 from coupling mechanism 3216 of wearable band 3210, allowing the user to use watch body 3220 independently from wearable band 3210 and vice versa. For example, decoupling watch body 3220 from wearable band 3210 can allow a user to capture images using rear-facing camera 3225b. Although release mechanism 3229 is shown positioned at a corner of watch body 3220, release mechanism 3229 can be positioned anywhere on watch body 3220 that is convenient for the user to actuate. In addition, in some embodiments, wearable band 3210 can also include a respective release mechanism for decoupling watch body 3220 from coupling mechanism 3216. In some embodiments, release mechanism 3229 is optional and watch body 3220 can be decoupled from coupling mechanism 3216 as described above (e.g., via twisting, rotating, etc.).

Watch body 3220 can include one or more peripheral buttons 3223 and 3227 for performing various operations at watch body 3220. For example, peripheral buttons 3223 and 3227 can be used to turn on or wake (e.g., transition from a sleep state to an active state) display 3205, unlock watch body 3220, increase or decrease a volume, increase or decrease a brightness, interact with one or more applications, interact with one or more user interfaces, etc. Additionally or alternatively, in some embodiments, display 3205 operates as a touch screen and allows the user to provide one or more inputs for interacting with watch body 3220.

In some embodiments, watch body 3220 includes one or more sensors 3221. Sensors 3221 of watch body 3220 can be the same or distinct from sensors 3213 of wearable band 3210. Sensors 3221 of watch body 3220 can be distributed on an inside and/or an outside surface of watch body 3220. In some embodiments, sensors 3221 are configured to contact a user's skin when watch body 3220 is worn by the user. For example, sensors 3221 can be placed on the bottom side of watch body 3220 and coupling mechanism 3216 can be a cradle with an opening that allows the bottom side of watch body 3220 to directly contact the user's skin. Alternatively, in some embodiments, watch body 3220 does not include sensors that are configured to contact the user's skin (e.g., including sensors internal and/or external to the watch body 3220 that are configured to sense data of watch body 3220 and the surrounding environment). In some embodiments, sensors 3221 are configured to track a position and/or motion of watch body 3220.

Watch body 3220 and wearable band 3210 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 3220 and wearable band 3210 can share data sensed by sensors 3213 and 3221, as well as application and device specific information (e.g., active and/or available applications, output devices (e.g., displays, speakers, etc.), input devices (e.g., touch screens, microphones, imaging sensors, etc.).

In some embodiments, watch body 3220 can include, without limitation, a front-facing camera 3225a and/or a rear-facing camera 3225b, sensors 3221 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 3363), a touch sensor, a sweat sensor, etc.). In some embodiments, watch body 3220 can include one or more haptic devices 3376 (e.g., a vibratory haptic actuator) that is configured to provide haptic feedback (e.g., a cutaneous and/or kinesthetic sensation, etc.) to the user. Sensors 3321 and/or haptic device 3376 can also be configured to operate in conjunction with multiple applications including, without limitation, health monitoring applications, social media applications, game applications, and artificial reality applications (e.g., the applications associated with artificial reality).

As described above, watch body 3220 and wearable band 3210, when coupled, can form wrist-wearable device 3200. When coupled, watch body 3220 and wearable band 3210 may operate as a single device to execute functions (operations, detections, communications, etc.) described herein. In some embodiments, each device may be provided with particular instructions for performing the one or more operations of wrist-wearable device 3200. For example, in accordance with a determination that watch body 3220 does not include neuromuscular signal sensors, wearable band 3210 can include alternative instructions for performing associated instructions (e.g., providing sensed neuromuscular signal data to watch body 3220 via a different electronic device). Operations of wrist-wearable device 3200 can be performed by watch body 3220 alone or in conjunction with wearable band 3210 (e.g., via respective processors and/or hardware components) and vice versa. In some embodiments, operations of wrist-wearable device 3200, watch body 3220, and/or wearable band 3210 can be performed in conjunction with one or more processors and/or hardware components.

As described below with reference to the block diagram of FIG. 33, wearable band 3210 and/or watch body 3220 can each include independent resources required to independently execute functions. For example, wearable band 3210 and/or watch body 3220 can each include a power source (e.g., a battery), a memory, data storage, a processor (e.g., a central processing unit (CPU)), communications, a light source, and/or input/output devices.

FIG. 33 shows block diagrams of a computing system 3330 corresponding to wearable band 3210 and a computing system 3360 corresponding to watch body 3220 according to some embodiments. Computing system 3300 of wrist-wearable device 3200 may include a combination of components of wearable band computing system 3330 and watch body computing system 3360, in accordance with some embodiments.

Watch body 3220 and/or wearable band 3210 can include one or more components shown in watch body computing system 3360. In some embodiments, a single integrated circuit may include all or a substantial portion of the components of watch body computing system 3360 included in a single integrated circuit. Alternatively, in some embodiments, components of the watch body computing system 3360 may be included in a plurality of integrated circuits that are communicatively coupled. In some embodiments, watch body computing system 3360 may be configured to couple (e.g., via a wired or wireless connection) with wearable band computing system 3330, which may allow the computing systems to share components, distribute tasks, and/or perform other operations described herein (individually or as a single device).

Watch body computing system 3360 can include one or more processors 3379, a controller 3377, a peripherals interface 3361, a power system 3395, and memory (e.g., a memory 3380).

Power system 3395 can include a charger input 3396, a power-management integrated circuit (PMIC) 3397, and a battery 3398. In some embodiments, a watch body 3220 and a wearable band 3210 can have respective batteries (e.g., battery 3398 and 3359) and can share power with each other. Watch body 3220 and wearable band 3210 can receive a charge using a variety of techniques. In some embodiments, watch body 3220 and wearable band 3210 can use a wired charging assembly (e.g., power cords) to receive the charge. Alternatively, or in addition, watch body 3220 and/or wearable band 3210 can be configured for wireless charging. For example, a portable charging device can be designed to mate with a portion of watch body 3220 and/or wearable band 3210 and wirelessly deliver usable power to battery 3398 of watch body 3220 and/or battery 3359 of wearable band 3210. Watch body 3220 and wearable band 3210 can have independent power systems (e.g., power system 3395 and 3356, respectively) to enable each to operate independently. Watch body 3220 and wearable band 3210 can also share power (e.g., one can charge the other) via respective PMICs (e.g., PMICs 3397 and 3358) and charger inputs (e.g., 3357 and 3396) that can share power over power and ground conductors and/or over wireless charging antennas.

In some embodiments, peripherals interface 3361 can include one or more sensors 3321. Sensors 3321 can include one or more coupling sensors 3362 for detecting when watch body 3220 is coupled with another electronic device (e.g., a wearable band 3210). Sensors 3321 can include one or more imaging sensors 3363 (e.g., one or more of cameras 3325, and/or separate imaging sensors 3363 (e.g., thermal-imaging sensors)). In some embodiments, sensors 3321 can include one or more SpO2 sensors 3364. In some embodiments, sensors 3321 can include one or more biopotential-signal sensors (e.g., EMG sensors 3365, which may be disposed on an interior, user-facing portion of watch body 3220 and/or wearable band 3210). In some embodiments, sensors 3321 may include one or more capacitive sensors 3366. In some embodiments, sensors 3321 may include one or more heart rate sensors 3367. In some embodiments, sensors 3321 may include one or more IMU sensors 3368. In some embodiments, one or more IMU sensors 3368 can be configured to detect movement of a user's hand or other location where watch body 3220 is placed or held.

In some embodiments, one or more of sensors 3321 may provide an example human-machine interface. For example, a set of neuromuscular sensors, such as EMG sensors 3365, may be arranged circumferentially around wearable band 3210 with an interior surface of EMG sensors 3365 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 3210 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 3379. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 3365 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 3361 includes a near-field communication (NFC) component 3369, a global-position system (GPS) component 3370, a long-term evolution (LTE) component 3371, and/or a Wi-Fi and/or Bluetooth communication component 3372. In some embodiments, peripherals interface 3361 includes one or more buttons 3373 (e.g., peripheral buttons 3223 and 3227 in FIG. 32), which, when selected by a user, cause operation to be performed at watch body 3220. In some embodiments, the peripherals interface 3361 includes one or more indicators, such as a light emitting diode (LED), to provide a user with visual indicators (e.g., message received, low battery, active microphone and/or camera, etc.).

Watch body 3220 can include at least one display 3205 for displaying visual representations of information or data to a user, including user-interface elements and/or three-dimensional virtual objects. The display can also include a touch screen for inputting user inputs, such as touch gestures, swipe gestures, and the like. Watch body 3220 can include at least one speaker 3374 and at least one microphone 3375 for providing audio signals to the user and receiving audio input from the user. The user can provide user inputs through microphone 3375 and can also receive audio output from speaker 3374 as part of a haptic event provided by haptic controller 3378. Watch body 3220 can include at least one camera 3325, including a front camera 3325a and a rear camera 3325b. Cameras 3325 can include ultra-wide-angle cameras, wide angle cameras, fish-eye cameras, spherical cameras, telephoto cameras, depth-sensing cameras, or other types of cameras.

Watch body computing system 3360 can include one or more haptic controllers 3378 and associated componentry (e.g., haptic devices 3376) for providing haptic events at watch body 3220 (e.g., a vibrating sensation or audio output in response to an event at the watch body 3220). Haptic controllers 3378 can communicate with one or more haptic devices 3376, such as electroacoustic devices, including a speaker of the one or more speakers 3374 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 3378 can provide haptic events to that are capable of being sensed by a user of watch body 3220. In some embodiments, one or more haptic controllers 3378 can receive input signals from an application of applications 3382.

In some embodiments, wearable band computing system 3330 and/or watch body computing system 3360 can include memory 3380, which can be controlled by one or more memory controllers of controllers 3377. In some embodiments, software components stored in memory 3380 include one or more applications 3382 configured to perform operations at the watch body 3220. In some embodiments, one or more applications 3382 may include games, word processors, messaging applications, calling applications, web browsers, social media applications, media streaming applications, financial applications, calendars, clocks, etc. In some embodiments, software components stored in memory 3380 include one or more communication interface modules 3383 as defined above. In some embodiments, software components stored in memory 3380 include one or more graphics modules 3384 for rendering, encoding, and/or decoding audio and/or visual data and one or more data management modules 3385 for collecting, organizing, and/or providing access to data 3387 stored in memory 3380. In some embodiments, one or more of applications 3382 and/or one or more modules can work in conjunction with one another to perform various tasks at the watch body 3220.

In some embodiments, software components stored in memory 3380 can include one or more operating systems 3381 (e.g., a Linux-based operating system, an Android operating system, etc.). Memory 3380 can also include data 3387. Data 3387 can include profile data 3388A, sensor data 3389A, media content data 3390, and application data 3391.

It should be appreciated that watch body computing system 3360 is an example of a computing system within watch body 3220, and that watch body 3220 can have more or fewer components than shown in watch body computing system 3360, can combine two or more components, and/or can have a different configuration and/or arrangement of the components. The various components shown in watch body computing system 3360 are implemented in hardware, software, firmware, or a combination thereof, including one or more signal processing and/or application-specific integrated circuits.

Turning to the wearable band computing system 3330, one or more components that can be included in wearable band 3210 are shown. Wearable band computing system 3330 can include more or fewer components than shown in watch body computing system 3360, can combine two or more components, and/or can have a different configuration and/or arrangement of some or all of the components. In some embodiments, all, or a substantial portion of the components of wearable band computing system 3330 are included in a single integrated circuit. Alternatively, in some embodiments, components of wearable band computing system 3330 are included in a plurality of integrated circuits that are communicatively coupled. As described above, in some embodiments, wearable band computing system 3330 is configured to couple (e.g., via a wired or wireless connection) with watch body computing system 3360, which allows the computing systems to share components, distribute tasks, and/or perform other operations described herein (individually or as a single device).

Wearable band computing system 3330, similar to watch body computing system 3360, can include one or more processors 3349, one or more controllers 3347 (including one or more haptics controllers 3348), a peripherals interface 3331 that can includes one or more sensors 3313 and other peripheral devices, a power source (e.g., a power system 3356), and memory (e.g., a memory 3350) that includes an operating system (e.g., an operating system 3351), data (e.g., data 3354 including profile data 3388B, sensor data 3389B, etc.), and one or more modules (e.g., a communications interface module 3352, a data management module 3353, etc.).

One or more of sensors 3313 can be analogous to sensors 3321 of watch body computing system 3360. For example, sensors 3313 can include one or more coupling sensors 3332, one or more SpO2 sensors 3334, one or more EMG sensors 3335, one or more capacitive sensors 3336, one or more heart rate sensors 3337, and one or more IMU sensors 3338.

Peripherals interface 3331 can also include other components analogous to those included in peripherals interface 3361 of watch body computing system 3360, including an NFC component 3339, a GPS component 3340, an LTE component 3341, a Wi-Fi and/or Bluetooth communication component 3342, and/or one or more haptic devices 3346 as described above in reference to peripherals interface 3361. In some embodiments, peripherals interface 3331 includes one or more buttons 3343, a display 3333, a speaker 3344, a microphone 3345, and a camera 3355. In some embodiments, peripherals interface 3331 includes one or more indicators, such as an LED.

It should be appreciated that wearable band computing system 3330 is an example of a computing system within wearable band 3210, and that wearable band 3210 can have more or fewer components than shown in wearable band computing system 3330, combine two or more components, and/or have a different configuration and/or arrangement of the components. The various components shown in wearable band computing system 3330 can be implemented in one or more of a combination of hardware, software, or firmware, including one or more signal processing and/or application-specific integrated circuits.

Wrist-wearable device 3200 with respect to FIG. 32 is an example of wearable band 3210 and watch body 3220 coupled together, so wrist-wearable device 3200 will be understood to include the components shown and described for wearable band computing system 3330 and watch body computing system 3360. In some embodiments, wrist-wearable device 3200 has a split architecture (e.g., a split mechanical architecture, a split electrical architecture, etc.) between watch body 3220 and wearable band 3210. In other words, all of the components shown in wearable band computing system 3330 and watch body computing system 3360 can be housed or otherwise disposed in a combined wrist-wearable device 3200 or within individual components of watch body 3220, wearable band 3210, and/or portions thereof (e.g., a coupling mechanism 3216 of wearable band 3210).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 3200 can be used in conjunction with a head-wearable device (e.g., AR glasses 3400 and VR system 3510) and/or an HIPD 3700 described below, and wrist-wearable device 3200 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 3400 and VR headset 3510.

FIGS. 34 to 36 show example artificial-reality systems, which can be used as or in connection with wrist-wearable device 3200. In some embodiments, AR system 3400 includes an eyewear device 3402, as shown in FIG. 34. In some embodiments, VR system 3510 includes a head-mounted display (HMD) 3512, as shown in FIGS. 35A and 35B. In some embodiments, AR system 3400 and VR system 3510 can include one or more analogous components (e.g., components for presenting interactive artificial-reality environments, such as processors, memory, and/or presentation devices, including one or more displays and/or one or more waveguides), some of which are described in more detail with respect to FIG. 36. As described herein, a head-wearable device can include components of eyewear device 3402 and/or head-mounted display 3512. Some embodiments of head-wearable devices do not include any displays, including any of the displays described with respect to AR system 3400 and/or VR system 3510. While the example artificial-reality systems are respectively described herein as AR system 3400 and VR system 3510, either or both of the example AR systems described herein can be configured to present fully-immersive virtual-reality scenes presented in substantially all of a user's field of view or subtler augmented-reality scenes that are presented within a portion, less than all, of the user's field of view.

FIG. 34 show an example visual depiction of AR system 3400, including an eyewear device 3402 (which may also be described herein as augmented-reality glasses, and/or smart glasses). AR system 3400 can include additional electronic components that are not shown in FIG. 34, such as a wearable accessory device and/or an intermediary processing device, in electronic communication or otherwise configured to be used in conjunction with the eyewear device 3402. In some embodiments, the wearable accessory device and/or the intermediary processing device may be configured to couple with eyewear device 3402 via a coupling mechanism in electronic communication with a coupling sensor 3624 (FIG. 36), where coupling sensor 3624 can detect when an electronic device becomes physically or electronically coupled with eyewear device 3402. In some embodiments, eyewear device 3402 can be configured to couple to a housing 3690 (FIG. 36), which may include one or more additional coupling mechanisms configured to couple with additional accessory devices. The components shown in FIG. 34 can be implemented in hardware, software, firmware, or a combination thereof, including one or more signal-processing components and/or application-specific integrated circuits (ASICs).

Eyewear device 3402 includes mechanical glasses components, including a frame 3404 configured to hold one or more lenses (e.g., one or both lenses 3406-1 and 3406-2). One of ordinary skill in the art will appreciate that eyewear device 3402 can include additional mechanical components, such as hinges configured to allow portions of frame 3404 of eyewear device 3402 to be folded and unfolded, a bridge configured to span the gap between lenses 3406-1 and 3406-2 and rest on the user's nose, nose pads configured to rest on the bridge of the nose and provide support for eyewear device 3402, earpieces configured to rest on the user's ears and provide additional support for eyewear device 3402, temple arms configured to extend from the hinges to the earpieces of eyewear device 3402, and the like. One of ordinary skill in the art will further appreciate that some examples of AR system 3400 can include none of the mechanical components described herein. For example, smart contact lenses configured to present artificial reality to users may not include any components of eyewear device 3402.

Eyewear device 3402 includes electronic components, many of which will be described in more detail below with respect to FIG. 10. Some example electronic components are illustrated in FIG. 34, including acoustic sensors 3425-1, 3425-2, 3425-3, 3425-4, 3425-5, and 3425-6, which can be distributed along a substantial portion of the frame 3404 of eyewear device 3402. Eyewear device 3402 also includes a left camera 3439A and a right camera 3439B, which are located on different sides of the frame 3404. Eyewear device 3402 also includes a processor 3448 (or any other suitable type or form of integrated circuit) that is embedded into a portion of the frame 3404.

FIGS. 35A and 35B show a VR system 3510 that includes a head-mounted display (HMD) 3512 (e.g., also referred to herein as an artificial-reality headset, a head-wearable device, a VR headset, etc.), in accordance with some embodiments. As noted, some artificial-reality systems (e.g., AR system 3400) may, instead of blending an artificial reality with actual reality, substantially replace one or more of a user's visual and/or other sensory perceptions of the real world with a virtual experience (e.g., AR systems 3000 and 3100).

HMD 3512 includes a front body 3514 and a frame 3516 (e.g., a strap or band) shaped to fit around a user's head. In some embodiments, front body 3514 and/or frame 3516 include one or more electronic elements for facilitating presentation of and/or interactions with an AR and/or VR system (e.g., displays, IMUs, tracking emitter or detectors). In some embodiments, HMD 3512 includes output audio transducers (e.g., an audio transducer 3518), as shown in FIG. 35B. In some embodiments, one or more components, such as the output audio transducer(s) 3518 and frame 3516, can be configured to attach and detach (e.g., are detachably attachable) to HMD 3512 (e.g., a portion or all of frame 3516, and/or audio transducer 3518), as shown in FIG. 35B. In some embodiments, coupling a detachable component to HMD 3512 causes the detachable component to come into electronic communication with HMD 3512.

FIGS. 35A and 35B also show that VR system 3510 includes one or more cameras, such as left camera 3539A and right camera 3539B, which can be analogous to left and right cameras 3439A and 3439B on frame 3404 of eyewear device 3402. In some embodiments, VR system 3510 includes one or more additional cameras (e.g., cameras 3539C and 3539D), which can be configured to augment image data obtained by left and right cameras 3539A and 3539B by providing more information. For example, camera 3539C can be used to supply color information that is not discerned by cameras 3539A and 3539B. In some embodiments, one or more of cameras 3539A to 3539D can include an optional IR cut filter configured to remove IR light from being received at the respective camera sensors.

FIG. 36 illustrates a computing system 3620 and an optional housing 3690, each of which show components that can be included in AR system 3400 and/or VR system 3510. In some embodiments, more or fewer components can be included in optional housing 3690 depending on practical restraints of the respective AR system being described.

In some embodiments, computing system 3620 can include one or more peripherals interfaces 3622A and/or optional housing 3690 can include one or more peripherals interfaces 3622B. Each of computing system 3620 and optional housing 3690 can also include one or more power systems 3642A and 3642B, one or more controllers 3646 (including one or more haptic controllers 3647), one or more processors 3648A and 3648B (as defined above, including any of the examples provided), and memory 3650A and 3650B, which can all be in electronic communication with each other. For example, the one or more processors 3648A and 3648B can be configured to execute instructions stored in memory 3650A and 3650B, which can cause a controller of one or more of controllers 3646 to cause operations to be performed at one or more peripheral devices connected to peripherals interface 3622A and/or 3622B. In some embodiments, each operation described can be powered by electrical power provided by power system 3642A and/or 3642B.

In some embodiments, peripherals interface 3622A can include one or more devices configured to be part of computing system 3620, some of which have been defined above and/or described with respect to the wrist-wearable devices shown in FIGS. 32 and 33. For example, peripherals interface 3622A can include one or more sensors 3623A. Some example sensors 3623A include one or more coupling sensors 3624, one or more acoustic sensors 3625, one or more imaging sensors 3626, one or more EMG sensors 3627, one or more capacitive sensors 3628, one or more IMU sensors 3629, and/or any other types of sensors explained above or described with respect to any other embodiments discussed herein.

In some embodiments, peripherals interfaces 3622A and 3622B can include one or more additional peripheral devices, including one or more NFC devices 3630, one or more GPS devices 3631, one or more LTE devices 3632, one or more Wi-Fi and/or Bluetooth devices 3633, one or more buttons 3634 (e.g., including buttons that are slidable or otherwise adjustable), one or more displays 3635A and 3635B, one or more speakers 3636A and 3636B, one or more microphones 3637, one or more cameras 3638A and 3638B (e.g., including the left camera 3639A and/or a right camera 3639B), one or more haptic devices 3640, and/or any other types of peripheral devices defined above or described with respect to any other embodiments discussed herein.

AR systems can include a variety of types of visual feedback mechanisms (e.g., presentation devices). For example, display devices in AR system 3400 and/or VR system 3510 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 3635A and 3635B can be coupled to each of the lenses 3406-1 and 3406-2 of AR system 3400. Displays 3635A and 3635B may be coupled to each of lenses 3406-1 and 3406-2, which can act together or independently to present an image or series of images to a user. In some embodiments, AR system 3400 includes a single display 3635A or 3635B (e.g., a near-eye display) or more than two displays 3635A and 3635B. In some embodiments, a first set of one or more displays 3635A and 3635B can be used to present an augmented-reality environment, and a second set of one or more display devices 3635A and 3635B can be used to present a virtual-reality environment. In some embodiments, one or more waveguides are used in conjunction with presenting artificial-reality content to the user of AR system 3400 (e.g., as a means of delivering light from one or more displays 3635A and 3635B to the user's eyes). In some embodiments, one or more waveguides are fully or partially integrated into the eyewear device 3402. Additionally, or alternatively to display screens, some artificial-reality systems include one or more projection systems. For example, display devices in AR system 3400 and/or VR system 3510 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 3635A and 3635B.

Computing system 3620 and/or optional housing 3690 of AR system 3400 or VR system 3510 can include some or all of the components of a power system 3642A and 3642B. Power systems 3642A and 3642B can include one or more charger inputs 3643, one or more PMICs 3644, and/or one or more batteries 3645A and 3644B.

Memory 3650A and 3650B may include instructions and data, some or all of which may be stored as non-transitory computer-readable storage media within the memories 3650A and 3650B. For example, memory 3650A and 3650B can include one or more operating systems 3651, one or more applications 3652, one or more communication interface applications 3653A and 3653B, one or more graphics applications 3654A and 3654B, one or more AR processing applications 3655A and 3655B, and/or any other types of data defined above or described with respect to any other embodiments discussed herein.

Memory 3650A and 3650B also include data 3660A and 3660B, which can be used in conjunction with one or more of the applications discussed above. Data 3660A and 3660B can include profile data 3661, sensor data 3662A and 3662B, media content data 3663A, AR application data 3664A and 3664B, and/or any other types of data defined above or described with respect to any other embodiments discussed herein.

In some embodiments, controller 3646 of eyewear device 3402 may process information generated by sensors 3623A and/or 3623B on eyewear device 3402 and/or another electronic device within AR system 3400. For example, controller 3646 can process information from acoustic sensors 3425-1 and 3425-2. For each detected sound, controller 3646 can perform a direction of arrival (DOA) estimation to estimate a direction from which the detected sound arrived at eyewear device 3402 of R system 3400. As one or more of acoustic sensors 3625 (e.g., the acoustic sensors 3425-1, 3425-2) detects sounds, controller 3646 can populate an audio data set with the information (e.g., represented in FIG. 10 as sensor data 3662A and 3662B).

In some embodiments, a physical electronic connector can convey information between eyewear device 3402 and another electronic device and/or between one or more processors 3448, 3648A, 3648B of AR system 3400 or VR system 3510 and controller 3646. The information can be in the form of optical data, electrical data, wireless data, or any other transmittable data form. Moving the processing of information generated by eyewear device 3402 to an intermediary processing device can reduce weight and heat in the eyewear device, making it more comfortable and safer for a user. In some embodiments, an optional wearable accessory device (e.g., an electronic neckband) is coupled to eyewear device 3402 via one or more connectors. The connectors can be wired or wireless connectors and can include electrical and/or non-electrical (e.g., structural) components. In some embodiments, eyewear device 3402 and the wearable accessory device can operate independently without any wired or wireless connection between them.

In some situations, pairing external devices, such as an intermediary processing device (e.g., HIPD 2806, 2906, 3006) with eyewear device 3402 (e.g., as part of AR system 3400) enables eyewear device 3402 to achieve a similar form factor of a pair of glasses while still providing sufficient battery and computation power for expanded capabilities. Some, or all, of the battery power, computational resources, and/or additional features of AR system 3400 can be provided by a paired device or shared between a paired device and eyewear device 3402, thus reducing the weight, heat profile, and form factor of eyewear device 3402 overall while allowing eyewear device 3402 to retain its desired functionality. For example, the wearable accessory device can allow components that would otherwise be included on eyewear device 3402 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 3402 standing alone. Because weight carried in the wearable accessory device can be less invasive to a user than weight carried in the eyewear device 3402, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 3400 and/or VR system 3510 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 35A and 35B show VR system 3510 having cameras 3539A to 3539D, which can be used to provide depth information for creating a voxel field and a two-dimensional mesh to provide object information to the user to avoid collisions.

In some embodiments, AR system 3400 and/or VR system 3510 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 3400 and/or VR system 3510, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

FIGS. 37A and 37B illustrate an example handheld intermediary processing device (HIPD) 3700 in accordance with some embodiments. HIPD 3700 is an instance of the intermediary device described herein, such that HIPD 3700 should be understood to have the features described with respect to any intermediary device defined above or otherwise described herein and vice versa. FIG. 37A shows a top view and FIG. 37B shows a side view of the HIPD 3700. HIPD 3700 is configured to communicatively couple with one or more wearable devices (or other electronic devices) associated with a user. For example, HIPD 3700 is configured to communicatively couple with a user's wrist-wearable device 2802, 2902 (or components thereof, such as watch body 3220 and wearable band 3210), AR glasses 3400, and/or VR headset 3050 and 3500. HIPD 3700 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which HIPD 3700 can successfully be communicatively coupled with an electronic device, such as a wearable device).

HIPD 3700 can perform various functions independently and/or in conjunction with one or more wearable devices (e.g., wrist-wearable device 2802, AR glasses 3400, VR system 3510, etc.). HIPD 3700 can be configured to increase and/or improve the functionality of communicatively coupled devices, such as the wearable devices. HIPD 3700 can be configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 28-30B. Additionally, as will be described in more detail below, functionality and/or operations of HIPD 3700 can include, without limitation, task offloading and/or handoffs; thermals offloading and/or handoffs; six degrees of freedom (6DoF) raycasting and/or gaming (e.g., using imaging devices or cameras 3714A, 3714B, which can be used for simultaneous localization and mapping (SLAM) and/or with other image processing techniques), portable charging, messaging, image capturing via one or more imaging devices or cameras 3722A and 3722B, sensing user input (e.g., sensing a touch on a touch input surface 3702), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 3700 and/or in communication between HIPD 3700 and another wearable device described herein. In some embodiments, functions can be executed on HIPD 3700 in conjunction with an AR environment. As the skilled artisan will appreciate upon reading the descriptions provided herein that HIPD 3700 can be used with any type of suitable AR environment.

While HIPD 3700 is communicatively coupled with a wearable device and/or other electronic device, HIPD 3700 is configured to perform one or more operations initiated at the wearable device and/or the other electronic device. In particular, one or more operations of the wearable device and/or the other electronic device can be offloaded to HIPD 3700 to be performed. HIPD 3700 performs the one or more operations of the wearable device and/or the other electronic device and provides to data corresponded to the completed operations to the wearable device and/or the other electronic device. For example, a user can initiate a video stream using AR glasses 3400 and back-end tasks associated with performing the video stream (e.g., video rendering) can be offloaded to HIPD 3700, which HIPD 3700 performs and provides corresponding data to AR glasses 3400 to perform remaining front-end tasks associated with the video stream (e.g., presenting the rendered video data via a display of AR glasses 3400). In this way, HIPD 3700, which has more computational resources and greater thermal headroom than a wearable device, can perform computationally intensive tasks for the wearable device, thereby improving performance of an operation performed by the wearable device.

HIPD 3700 includes a multi-touch input surface 3702 on a first side (e.g., a front surface) that is configured to detect one or more user inputs. In particular, multi-touch input surface 3702 can detect single tap inputs, multi-tap inputs, swipe gestures and/or inputs, force-based and/or pressure-based touch inputs, held taps, and the like. Multi-touch input surface 3702 is configured to detect capacitive touch inputs and/or force (and/or pressure) touch inputs. Multi-touch input surface 3702 includes a first touch-input surface 3704 defined by a surface depression and a second touch-input surface 3706 defined by a substantially planar portion. First touch-input surface 3704 can be disposed adjacent to second touch-input surface 3706. In some embodiments, first touch-input surface 3704 and second touch-input surface 3706 can be different dimensions and/or shapes. For example, first touch-input surface 3704 can be substantially circular and second touch-input surface 3706 can be substantially rectangular. In some embodiments, the surface depression of multi-touch input surface 3702 is configured to guide user handling of HIPD 3700. In particular, the surface depression can be configured such that the user holds HIPD 3700 upright when held in a single hand (e.g., such that the using imaging devices or cameras 3714A and 3714B are pointed toward a ceiling or the sky). Additionally, the surface depression is configured such that the user's thumb rests within first touch-input surface 3704.

In some embodiments, the different touch-input surfaces include a plurality of touch-input zones. For example, second touch-input surface 3706 includes at least a second touch-input zone 3708 within a first touch-input zone 3707 and a third touch-input zone 3710 within second touch-input zone 3708. In some embodiments, one or more of touch-input zones 3708 and 3710 are optional and/or user defined (e.g., a user can specific a touch-input zone based on their preferences). In some embodiments, each touch-input surface 3704 and 3706 and/or touch-input zone 3708 and 3710 are associated with a predetermined set of commands. For example, a user input detected within first touch-input zone 3708 may cause HIPD 3700 to perform a first command and a user input detected within second touch-input surface 3706 may cause HIPD 3700 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, first touch-input zone 3708 can be configured to detect force touch inputs (e.g., a magnitude at which the user presses down) and capacitive touch inputs, and second touch-input zone 3710 can be configured to detect capacitive touch inputs.

As shown in FIG. 38, HIPD 3700 includes one or more sensors 3851 for sensing data used in the performance of one or more operations and/or functions. For example, HIPD 3700 can include an IMU sensor that is used in conjunction with cameras 3714A, 3714B (FIGS. 37A-37B) for 3-dimensional object manipulation (e.g., enlarging, moving, destroying, etc., an object) in an AR or VR environment. Non-limiting examples of sensors 3851 included in HIPD 3700 include a light sensor, a magnetometer, a depth sensor, a pressure sensor, and a force sensor.

HIPD 3700 can include one or more light indicators 3712 to provide one or more notifications to the user. In some embodiments, light indicators 3712 are LEDs or other types of illumination devices. Light indicators 3712 can operate as a privacy light to notify the user and/or others near the user that an imaging device and/or microphone are active. In some embodiments, a light indicator is positioned adjacent to one or more touch-input surfaces. For example, a light indicator can be positioned around first touch-input surface 3704. Light indicators 3712 can be illuminated in different colors and/or patterns to provide the user with one or more notifications and/or information about the device. For example, a light indicator positioned around first touch-input surface 3704 may flash when the user receives a notification (e.g., a message), change red when HIPD 3700 is out of power, operate as a progress bar (e.g., a light ring that is closed when a task is completed (e.g., 0% to 100%)), operate as a volume indicator, etc.

In some embodiments, HIPD 3700 includes one or more additional sensors on another surface. For example, as shown FIG. 37A, HIPD 3700 includes a set of one or more sensors (e.g., sensor set 3720) on an edge of HIPD 3700. Sensor set 3720, when positioned on an edge of the of HIPD 3700, can be pe positioned at a predetermined tilt angle (e.g., 26 degrees), which allows sensor set 3720 to be angled toward the user when placed on a desk or other flat surface. Alternatively, in some embodiments, sensor set 3720 is positioned on a surface opposite the multi-touch input surface 3702 (e.g., a back surface). The one or more sensors of sensor set 3720 are discussed in further detail below.

The side view of the of HIPD 3700 in FIG. 37B shows sensor set 3720 and camera 3714B. Sensor set 3720 can include one or more cameras 3722A and 3722B, a depth projector 3724, an ambient light sensor 3728, and a depth receiver 3730. In some embodiments, sensor set 3720 includes a light indicator 3726. Light indicator 3726 can operate as a privacy indicator to let the user and/or those around them know that a camera and/or microphone is active. Sensor set 3720 is configured to capture a user's facial expression such that the user can puppet a custom avatar (e.g., showing emotions, such as smiles, laughter, etc., on the avatar or a digital representation of the user). Sensor set 3720 can be configured as a side stereo RGB system, a rear indirect Time-of-Flight (iToF) system, or a rear stereo RGB system. As the skilled artisan will appreciate upon reading the descriptions provided herein, HIPD 3700 described herein can use different sensor set 3720 configurations and/or sensor set 3720 placement.

Turning to FIG. 38, in some embodiments, a computing system 3840 of HIPD 3700 can include one or more haptic devices 3871 (e.g., a vibratory haptic actuator) that are configured to provide haptic feedback (e.g., kinesthetic sensation). Sensors 3851 and/or the haptic devices 3871 can be configured to operate in conjunction with multiple applications and/or communicatively coupled devices including, without limitation, a wearable devices, health monitoring applications, social media applications, game applications, and artificial reality applications (e.g., the applications associated with artificial reality).

In some embodiments, HIPD 3700 is configured to operate without a display. However, optionally, computing system 3840 of the HIPD 3700 can include a display 3868. HIPD 3700 can also include one or more optional peripheral buttons 3867. For example, peripheral buttons 3867 can be used to turn on or turn off HIPD 3700. Further, HIPD 3700 housing can be formed of polymers and/or elastomers. In other words, HIPD 3700 may be designed such that it would not easily slide off a surface. In some embodiments, HIPD 3700 includes one or magnets to couple HIPD 3700 to another surface. This allows the user to mount HIPD 3700 to different surfaces and provide the user with greater flexibility in use of HIPD 3700.

As described above, HIPD 3700 can distribute and/or provide instructions for performing the one or more tasks at HIPD 3700 and/or a communicatively coupled device. For example, HIPD 3700 can identify one or more back-end tasks to be performed by HIPD 3700 and one or more front-end tasks to be performed by a communicatively coupled device. While HIPD 3700 is configured to offload and/or handoff tasks of a communicatively coupled device, HIPD 3700 can perform both back-end and front-end tasks (e.g., via one or more processors, such as CPU 3877). HIPD 3700 can, without limitation, can be used to perform augmented calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. HIPD 3700 can perform the above operations alone or in conjunction with a wearable device (or other communicatively coupled electronic device).

FIG. 38 shows a block diagram of a computing system 3840 of HIPD 3700 in accordance with some embodiments. HIPD 3700, described in detail above, can include one or more components shown in HIPD computing system 3840. HIPD 3700 will be understood to include the components shown and described below for HIPD computing system 3840. In some embodiments, all, or a substantial portion of the components of HIPD computing system 3840 are included in a single integrated circuit. Alternatively, in some embodiments, components of HIPD computing system 3840 are included in a plurality of integrated circuits that are communicatively coupled.

HIPD computing system 3840 can include a processor (e.g., a CPU 3877, a GPU, and/or a CPU with integrated graphics), a controller 3875, a peripherals interface 3850 that includes one or more sensors 3851 and other peripheral devices, a power source (e.g., a power system 3895), and memory (e.g., a memory 3878) that includes an operating system (e.g., an operating system 3879), data (e.g., data 3888), one or more applications (e.g., applications 3880), and one or more modules (e.g., a communications interface module 3881, a graphics module 3882, a task and processing management module 3883, an interoperability module 3884, an AR processing module 3885, a data management module 3886, etc.). HIPD computing system 3840 further includes a power system 3895 that includes a charger input and output 3896, a PMIC 3897, and a battery 3898, all of which are defined above.

In some embodiments, peripherals interface 3850 can include one or more sensors 3851. Sensors 3851 can include analogous sensors to those described above in reference to FIG. 32. For example, sensors 3851 can include imaging sensors 3854, (optional) EMG sensors 3856, IMU sensors 3858, and capacitive sensors 3860. In some embodiments, sensors 3851 can include one or more pressure sensors 3852 for sensing pressure data, an altimeter 3853 for sensing an altitude of the HIPD 3700, a magnetometer 3855 for sensing a magnetic field, a depth sensor 3857 (or a time-of flight sensor) for determining a difference between the camera and the subject of an image, a position sensor 3859 (e.g., a flexible position sensor) for sensing a relative displacement or position change of a portion of the HIPD 3700, a force sensor 3861 for sensing a force applied to a portion of the HIPD 3700, and a light sensor 3862 (e.g., an ambient light sensor) for detecting an amount of lighting. Sensors 3851 can include one or more sensors not shown in FIG. 38.

Analogous to the peripherals described above in reference to FIG. 32, peripherals interface 3850 can also include an NFC component 3863, a GPS component 3864, an LTE component 3865, a Wi-Fi and/or Bluetooth communication component 3866, a speaker 3869, a haptic device 3871, and a microphone 3873. As noted above, HIPD 3700 can optionally include a display 3868 and/or one or more peripheral buttons 3867. Peripherals interface 3850 can further include one or more cameras 3870, touch surfaces 3872, and/or one or more light emitters 3874. Multi-touch input surface 3702 described above in reference to FIGS. 37A and 37B is an example of touch surface 3872. Light emitters 3874 can be one or more LEDs, lasers, etc. and can be used to project or present information to a user. For example, light emitters 3874 can include light indicators 3712 and 3726 described above in reference to FIGS. 37A and 37B. Cameras 3870 (e.g., cameras 3714A, 3714B, 3722A, and 3722B described above in reference to FIGS. 37A and 37B) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other suitable cameras. Cameras 3870 can be used for SLAM, 6DoF ray casting, gaming, object manipulation and/or other rendering, facial recognition and facial expression recognition, etc.

Similar to watch body computing system 3360 and watch band computing system 3330 described above in reference to FIG. 33, HIPD computing system 3840 can include one or more haptic controllers 3876 and associated componentry (e.g., haptic devices 3871) for providing haptic events at HIPD 3700.

Memory 3878 can include high-speed random-access memory and/or non-volatile memory, such as one or more magnetic disk storage devices, flash memory devices, or other non-volatile solid-state memory devices. Access to memory 3878 by other components of HIPD 3700, such as the one or more processors and peripherals interface 3850, can be controlled by a memory controller of controllers 3875.

In some embodiments, software components stored in memory 3878 include one or more operating systems 3879, one or more applications 3880, one or more communication interface modules 3881, one or more graphics modules 3882, and/or one or more data management modules 3886, which are analogous to the software components described above in reference to FIG. 32.

In some embodiments, software components stored in memory 3878 include a task and processing management module 3883 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, task and processing management module 3883 uses data 3888 (e.g., device data 3890) to distribute the one or more front-end and/or back-end tasks based on communicatively coupled devices' computing resources, available power, thermal headroom, ongoing operations, and/or other factors. For example, task and processing management module 3883 can cause the performance of one or more back-end tasks (of an operation performed at communicatively coupled AR system 3400) at HIPD 3700 in accordance with a determination that the operation is utilizing a predetermined amount (e.g., at least 70%) of computing resources available at AR system 3400.

In some embodiments, software components stored in memory 3878 include an interoperability module 3884 for exchanging and utilizing information received and/or provided to distinct communicatively coupled devices. Interoperability module 3884 allows for different systems, devices, and/or applications to connect and communicate in a coordinated way without user input. In some embodiments, software components stored in memory 3878 include an AR processing module 3885 that is configured to process signals based at least on sensor data for use in an AR and/or VR environment. For example, AR processing module 3885 can be used for 3D object manipulation, gesture recognition, facial and facial expression recognition, etc.

Memory 3878 can also include data 3888. In some embodiments, data 3888 can include profile data 3889, device data 3890 (including device data of one or more devices communicatively coupled with HIPD 3700, such as device type, hardware, software, configurations, etc.), sensor data 3891, media content data 3892, and application data 3893.

It should be appreciated that HIPD computing system 3840 is an example of a computing system within HIPD 3700, and that HIPD 3700 can have more or fewer components than shown in HIPD computing system 3840, combine two or more components, and/or have a different configuration and/or arrangement of the components. The various components shown HIPD computing system 3840 are implemented in hardware, software, firmware, or a combination thereof, including one or more signal processing and/or application-specific integrated circuits.

The techniques described above in FIGS. 37A, 37B, and 38 can be used with any device used as a human-machine interface controller. In some embodiments, an HIPD 3700 can be used in conjunction with one or more wearable device such as a head-wearable device (e.g., AR system 3400 and VR system 3510) and/or a wrist-wearable device 3200 (or components thereof).

In some embodiments, the artificial reality devices and/or accessory devices disclosed herein may include haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback, may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user's artificial-reality experience in one or more of these contexts and environments and/or in other contexts and environments.

FIGS. 39A and 39B show example haptic feedback systems (e.g., hand-wearable devices) for providing feedback to a user regarding the user's interactions with a computing system (e.g., an artificial-reality environment presented by the AR system 3400 or the VR system 3510). In some embodiments, a computing system (e.g., the AR systems 3000 and/or 3100) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 3962 of haptic device 3900 (e.g., haptic assemblies 3962-1, 3962-2, 3962-3, etc.). For example, the haptic feedback may prevent (or, at a minimum, hinder/resist movement of) one or more fingers of a user from bending past a certain point to simulate the sensation of touching a solid coffee mug. In actuating such haptic effects, haptic device 3900 can change (either directly or indirectly) a pressurized state of one or more of haptic assemblies 3962.

Vibrotactile system 3900 may optionally include other subsystems and components, such as touch-sensitive pads, pressure sensors, motion sensors, position sensors, lighting elements, and/or user interface elements (e.g., an on/off button, a vibration control element, etc.). During use, haptic assemblies 3962 may be configured to be activated for a variety of different reasons, such as in response to the user's interaction with user interface elements, a signal from the motion or position sensors, a signal from the touch-sensitive pads, a signal from the pressure sensors, a signal from the other device or system, etc.

In FIGS. 39A and 39B, each of haptic assemblies 3962 may include a mechanism that, at a minimum, provides resistance when the respective haptic assembly 3962 is transitioned from a first pressurized state (e.g., atmospheric pressure or deflated) to a second pressurized state (e.g., inflated to a threshold pressure). Structures of haptic assemblies 3962 can be integrated into various devices configured to be in contact or proximity to a user's skin, including, but not limited to devices such as glove worn devices, body worn clothing device, headset devices.

As noted above, haptic assemblies 3962 described herein can be configured to transition between a first pressurized state and a second pressurized state to provide haptic feedback to the user. Due to the ever-changing nature of artificial-reality, haptic assemblies 3962 may be required to transition between the two states hundreds, or perhaps thousands of times, during a single use. Thus, haptic assemblies 3962 described herein are durable and designed to quickly transition from state to state. To provide some context, in the first pressurized state, haptic assemblies 3962 do not impede free movement of a portion of the wearer's body. For example, one or more haptic assemblies 3962 incorporated into a glove are made from flexible materials that do not impede free movement of the wearer's hand and fingers (e.g., an electrostatic-zipping actuator). Haptic assemblies 3962 may be configured to conform to a shape of the portion of the wearer's body when in the first pressurized state. However, once in the second pressurized state, haptic assemblies 3962 can be configured to restrict and/or impede free movement of the portion of the wearer's body (e.g., appendages of the user's hand). For example, the respective haptic assembly 3962 (or multiple respective haptic assemblies) can restrict movement of a wearer's finger (e.g., prevent the finger from curling or extending) when haptic assembly 3962 is in the second pressurized state. Moreover, once in the second pressurized state, haptic assemblies 3962 may take different shapes, with some haptic assemblies 3962 configured to take a planar, rigid shape (e.g., flat and rigid), while some other haptic assemblies 3962 are configured to curve or bend, at least partially.

As a non-limiting example, haptic device 3900 includes a plurality of haptic devices (e.g., a pair of haptic gloves, a haptics component of a wrist-wearable device (e.g., any of the wrist-wearable devices described with respect to FIGS. 28-32), etc.), each of which can include a garment component (e.g., a garment 3904) and one or more haptic assemblies coupled (e.g., physically coupled) to the garment component. For example, each of the haptic assemblies 3962-1, 3962-2, 3962-3, . . . 3962-N are physically coupled to the garment 3904 and are configured to contact respective phalanges of a user's thumb and fingers. As explained above, haptic assemblies 3962 are configured to provide haptic simulations to a wearer of device 3900. Garment 3904 of each device 3900 can be one of various articles of clothing (e.g., gloves, socks, shirts, pants, etc.). Thus, a user may wear multiple haptic devices 3900 that are each configured to provide haptic stimulations to respective parts of the body where haptic devices 3900 are being worn.

FIG. 40 shows block diagrams of a computing system 4040 of haptic device 3900, in accordance with some embodiments. Computing system 4040 can include one or more peripherals interfaces 4050, one or more power systems 4095, one or more controllers 4075 (including one or more haptic controllers 4076), one or more processors 4077 (as defined above, including any of the examples provided), and memory 4078, which can all be in electronic communication with each other. For example, one or more processors 4077 can be configured to execute instructions stored in the memory 4078, which can cause a controller of the one or more controllers 4075 to cause operations to be performed at one or more peripheral devices of peripherals interface 4050. In some embodiments, each operation described can occur based on electrical power provided by the power system 4095. The power system 4095 can include a charger input 4096, a PMIC 4097, and a battery 4098.

In some embodiments, peripherals interface 4050 can include one or more devices configured to be part of computing system 4040, many of which have been defined above and/or described with respect to wrist-wearable devices shown in FIGS. 32 and 33. For example, peripherals interface 4050 can include one or more sensors 4051. Some example sensors include: one or more pressure sensors 4052, one or more EMG sensors 4056, one or more IMU sensors 4058, one or more position sensors 4059, one or more capacitive sensors 4060, one or more force sensors 4061; and/or any other types of sensors defined above or described with respect to any other embodiments discussed herein.

In some embodiments, the peripherals interface can include one or more additional peripheral devices, including one or more Wi-Fi and/or Bluetooth devices 4068; one or more haptic assemblies 4062; one or more support structures 4063 (which can include one or more bladders 4064; one or more manifolds 4065; one or more pressure-changing devices 4067; and/or any other types of peripheral devices defined above or described with respect to any other embodiments discussed herein.

In some embodiments, each haptic assembly 4062 includes a support structure 4063 and at least one bladder 4064. Bladder 4064 (e.g., a membrane) may be a sealed, inflatable pocket made from a durable and puncture-resistant material, such as thermoplastic polyurethane (TPU), a flexible polymer, or the like. Bladder 4064 contains a medium (e.g., a fluid such as air, inert gas, or even a liquid) that can be added to or removed from bladder 4064 to change a pressure (e.g., fluid pressure) inside the bladder 4064. Support structure 4063 is made from a material that is stronger and stiffer than the material of bladder 4064. A respective support structure 4063 coupled to a respective bladder 4064 is configured to reinforce the respective bladder 4064 as the respective bladder 4064 changes shape and size due to changes in pressure (e.g., fluid pressure) inside the bladder.

The system 4040 also includes a haptic controller 4076 and a pressure-changing device 4067. In some embodiments, haptic controller 4076 is part of the computer system 4040 (e.g., in electronic communication with one or more processors 4077 of the computer system 4040). Haptic controller 4076 is configured to control operation of pressure-changing device 4067, and in turn operation of haptic device 3900. For example, haptic controller 4076 sends one or more signals to pressure-changing device 4067 to activate pressure-changing device 4067 (e.g., turn it on and off). The one or more signals may specify a desired pressure (e.g., pounds-per-square inch) to be output by pressure-changing device 4067. Generation of the one or more signals, and in turn the pressure output by pressure-changing device 4067, may be based on information collected by sensors 4051. For example, the one or more signals may cause pressure-changing device 4067 to increase the pressure (e.g., fluid pressure) inside a first haptic assembly 4062 at a first time, based on the information collected by sensors 4051 (e.g., the user makes contact with an artificial coffee mug or other artificial object). Then, the controller may send one or more additional signals to pressure-changing device 4067 that cause pressure-changing device 4067 to further increase the pressure inside first haptic assembly 4062 at a second time after the first time, based on additional information collected by sensors 4051. Further, the one or more signals may cause pressure-changing device 4067 to inflate one or more bladders 4064 in a first device 3900A, while one or more bladders 4064 in a second device 3900B remain unchanged. Additionally, the one or more signals may cause pressure-changing device 4067 to inflate one or more bladders 4064 in a first device 3900A to a first pressure and inflate one or more other bladders 4064 in first device 3900A to a second pressure different from the first pressure. Depending on number of devices 3900 serviced by pressure-changing device 4067, and the number of bladders therein, many different inflation configurations can be achieved through the one or more signals and the examples above are not meant to be limiting.

The system 4040 may include an optional manifold 4065 between pressure-changing device 4067 and haptic devices 3900. Manifold 4065 may include one or more valves (not shown) that pneumatically couple each of haptic assemblies 4062 with pressure-changing device 4067 via tubing. In some embodiments, manifold 4065 is in communication with controller 4075, and controller 4075 controls the one or more valves of manifold 4065 (e.g., the controller generates one or more control signals). Manifold 4065 is configured to switchably couple pressure-changing device 4067 with one or more haptic assemblies 4062 of the same or different haptic devices 3900 based on one or more control signals from controller 4075. In some embodiments, instead of using manifold 4065 to pneumatically couple pressure-changing device 4067 with haptic assemblies 4062, system 4040 may include multiple pressure-changing devices 4067, where each pressure-changing device 4067 is pneumatically coupled directly with a single haptic assembly 4062 or multiple haptic assemblies 4062. In some embodiments, pressure-changing device 4067 and optional manifold 4065 can be configured as part of one or more of the haptic devices 3900 while, in other embodiments, pressure-changing device 4067 and optional manifold 4065 can be configured as external to haptic device 3900. A single pressure-changing device 4067 may be shared by multiple haptic devices 3900.

In some embodiments, pressure-changing device 4067 is a pneumatic device, hydraulic device, a pneudraulic device, or some other device capable of adding and removing a medium (e.g., fluid, liquid, gas) from the one or more haptic assemblies 4062.

The devices shown in FIGS. 39A-40 may be coupled via a wired connection (e.g., via busing). Alternatively, one or more of the devices shown in FIGS. 39A-40 may be wirelessly connected (e.g., via short-range communication signals).

Memory 4078 includes instructions and data, some or all of which may be stored as non-transitory computer-readable storage media within memory 4078. For example, memory 4078 can include one or more operating systems 4079; one or more communication interface applications 4081; one or more interoperability modules 4084; one or more AR processing applications 4085; one or more data management modules 4086; and/or any other types of applications or modules defined above or described with respect to any other embodiments discussed herein.

Memory 4078 also includes data 4088 which can be used in conjunction with one or more of the applications discussed above. Data 4088 can include: device data 4090; sensor data 4091; and/or any other types of data defined above or described with respect to any other embodiments discussed herein.

Audio Boilerplate: Include the following audio boilerplate in any applications where the inventive concept is directed to microphones, speakers, directional audio, etc. Always include the preceding Artificial-Reality Boilerplate when using the Audio boilerplate.

In some examples, the augmented reality systems described herein may also include a microphone array with a plurality of acoustic transducers. Acoustic transducers may represent transducers that detect air pressure variations induced by sound waves. Each acoustic transducer may be configured to detect sound and convert the detected sound into an electronic format (e.g., an analog or digital format). A microphone array may include, for example, ten acoustic transducers that may be designed to be placed inside a corresponding ear of the user, acoustic transducers that may be positioned at various locations on an HMD frame a watch band, etc.

In some embodiments, one or more of acoustic transducers may be used as output transducers (e.g., speakers). For example, the artificial reality systems described herein may include acoustic transducers that are earbuds or any other suitable type of headphone or speaker.

The configuration of acoustic transducers of a microphone array may vary and may include any suitable number of transducers. In some embodiments, using higher numbers of acoustic transducers may increase the amount of audio information collected and/or the sensitivity and accuracy of the audio information. In contrast, using a lower number of acoustic transducers may decrease the computing power required by an associated controller to process the collected audio information. In addition, the position of each acoustic transducer of the microphone array may vary. For example, the position of an acoustic transducer may include a defined position on the user, a defined coordinate on a frame of an HMD, an orientation associated with each acoustic transducer, or some combination thereof.

Acoustic transducers and may be positioned on different parts of the user's ear, such as behind the pinna, behind the tragus, and/or within the auricle or fossa. Or, there may be additional acoustic transducers on or surrounding the ear in addition to acoustic transducers inside the ear canal. Having an acoustic transducer positioned next to an ear canal of a user may enable the microphone array to collect information on how sounds arrive at the ear canal. By positioning at least two of acoustic transducers on either side of a user's head (e.g., as binaural microphones), an artificial-reality device may simulate binaural hearing and capture a 3D stereo sound field around about a user's head. In some embodiments, acoustic transducers may be connected to artificial reality systems via a wired connection, and in other embodiments acoustic transducers may be connected to artificial-reality systems via a wireless connection (e.g., a BLUETOOTH connection).

Acoustic transducers may be positioned on HMDs frames in a variety of different ways, including along the length of the temples, across the bridge, above or below display devices, or some combination thereof. Acoustic transducers may also be oriented such that the microphone array is able to detect sounds in a wide range of directions surrounding the user wearing the augmented-reality system. In some embodiments, an optimization process may be performed during manufacturing of augmented-reality system to determine relative positioning of each acoustic transducer in the microphone array.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

Some augmented-reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may, for example, implement optical sensors to determine a user's location. Radios including WiFi, BLUETOOTH, global positioning system (GPS), cellular or other communication devices may be also used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. Augmented-reality and virtual-reality devices may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented-reality headset or virtual-reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented-reality or virtual-reality headset may initiate a DOA analysis to determine the location of a sound source. The DOA analysis may include analyzing the intensity, spectra, and/or arrival time of each sound at the artificial-reality device to determine the direction from which the sounds originated. The DOA analysis may include any suitable algorithm for analyzing the surrounding acoustic environment in which the artificial reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial-reality device may provide an alignment and orientation guide, which the user may follow to customize the sound signal presented to the user based on their unique HRTF. In some embodiments, an artificial reality device may implement one or more microphones to listen to sounds within the user's environment. The augmented reality or virtual reality headset may use a variety of different array transfer functions (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, IR sensors, heat sensors, motion sensors, GPS receivers, or in some cases, sensors that detect a user's eye movements. For example, as noted above, an artificial-reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some embodiments, the artificial-reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

FIG. 41 is an illustration of an example system 4100 that incorporates an eye-tracking subsystem capable of tracking a user's eye(s). As depicted in FIG. 41, system 4100 may include a light source 4102, an optical subsystem 4104, an eye-tracking subsystem 4106, and/or a control subsystem 4108. In some examples, light source 4102 may generate light for an image (e.g., to be presented to an eye 4101 of the viewer). Light source 4102 may represent any of a variety of suitable devices. For example, light source 4102 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 4104 may receive the light generated by light source 4102 and generate, based on the received light, converging light 4120 that includes the image. In some examples, optical subsystem 4104 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 4120. Further, various mechanical couplings may serve to maintain the relative spacing and/or the orientation of the optical components in any suitable combination.

In one embodiment, eye-tracking subsystem 4106 may generate tracking information indicating a gaze angle of an eye 4101 of the viewer. In this embodiment, control subsystem 4108 may control aspects of optical subsystem 4104 (e.g., the angle of incidence of converging light 4120) based at least in part on this tracking information. Additionally, in some examples, control subsystem 4108 may store and utilize historical tracking information (e.g., a history of the tracking information over a given duration, such as the previous second or fraction thereof) to anticipate the gaze angle of eye 4101 (e.g., an angle between the visual axis and the anatomical axis of eye 4101). In some embodiments, eye-tracking subsystem 4106 may detect radiation emanating from some portion of eye 4101 (e.g., the cornea, the iris, the pupil, or the like) to determine the current gaze angle of eye 4101. In other examples, eye-tracking subsystem 4106 may employ a wavefront sensor to track the current location of the pupil.

Any number of techniques can be used to track eye 4101. Some techniques may involve illuminating eye 4101 with infrared light and measuring reflections with at least one optical sensor that is tuned to be sensitive to the infrared light. Information about how the infrared light is reflected from eye 4101 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 4106 may be digitized (i.e., converted to an electronic signal). Further, the sensor may transmit a digital representation of this electronic signal to one or more processors (for example, processors associated with a device including eye-tracking subsystem 4106). Eye-tracking subsystem 4106 may include any of a variety of sensors in a variety of different configurations. For example, eye-tracking subsystem 4106 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 4106 to track the movement of eye 4101. In another example, these processors may track the movements of eye 4101 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 4106 may be programmed to use an output of the sensor(s) to track movement of eye 4101. In some embodiments, eye-tracking subsystem 4106 may analyze the digital representation generated by the sensors to extract eye rotation information from changes in reflections. In one embodiment, eye-tracking subsystem 4106 may use corneal reflections or glints (also known as Purkinje images) and/or the center of the eye's pupil 4122 as features to track over time.

In some embodiments, eye-tracking subsystem 4106 may use the center of the eye's pupil 4122 and infrared or near-infrared, non-collimated light to create corneal reflections. In these embodiments, eye-tracking subsystem 4106 may use the vector between the center of the eye's pupil 4122 and the corneal reflections to compute the gaze direction of eye 4101. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 4106 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 4101 may act as a retroreflector as the light reflects off the retina, thereby creating a bright pupil effect similar to a red-eye effect in photography. If the illumination source is offset from the optical path, then the eye's pupil 4122 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 4108 may control light source 4102 and/or optical subsystem 4104 to reduce optical aberrations (e.g., chromatic aberrations and/or monochromatic aberrations) of the image that may be caused by or influenced by eye 4101. In some examples, as mentioned above, control subsystem 4108 may use the tracking information from eye-tracking subsystem 4106 to perform such control. For example, in controlling light source 4102, control subsystem 4108 may alter the light generated by light source 4102 (e.g., by way of image rendering) to modify (e.g., pre-distort) the image so that the aberration of the image caused by eye 4101 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

FIG. 42 is a more detailed illustration of various aspects of the eye-tracking subsystem illustrated in FIG. 41. As shown in this figure, an eye-tracking subsystem 4200 may include at least one source 4204 and at least one sensor 4206. Source 4204 generally represents any type or form of element capable of emitting radiation. In one example, source 4204 may generate visible, infrared, and/or near-infrared radiation. In some examples, source 4204 may radiate non-collimated infrared and/or near-infrared portions of the electromagnetic spectrum towards an eye 4202 of a user. Source 4204 may utilize a variety of sampling rates and speeds. For example, the disclosed systems may use sources with higher sampling rates in order to capture fixational eye movements of a user's eye 4202 and/or to correctly measure saccade dynamics of the user's eye 4202. As noted above, any type or form of eye-tracking technique may be used to track the user's eye 4202, including optical-based eye-tracking techniques, ultrasound-based eye-tracking techniques, etc.

Sensor 4206 generally represents any type or form of element capable of detecting radiation, such as radiation reflected off the user's eye 4202. Examples of sensor 4206 include, without limitation, a charge coupled device (CCD), a photodiode array, a complementary metal-oxide-semiconductor (CMOS) based sensor device, and/or the like. In one example, sensor 4206 may represent a sensor having predetermined parameters, including, but not limited to, a dynamic resolution range, linearity, and/or other characteristic selected and/or designed specifically for eye tracking.

As detailed above, eye-tracking subsystem 4200 may generate one or more glints. As detailed above, a glint 4203 may represent reflections of radiation (e.g., infrared radiation from an infrared source, such as source 4204) from the structure of the user's eye. In various embodiments, glint 4203 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 42 shows an example image 4205 captured by an eye-tracking subsystem, such as eye-tracking subsystem 4200. In this example, image 4205 may include both the user's pupil 4208 and a glint 4210 near the same. In some examples, pupil 4208 and/or glint 4210 may be identified using an artificial-intelligence-based algorithm, such as a computer-vision-based algorithm. In one embodiment, image 4205 may represent a single frame in a series of frames that may be analyzed continuously in order to track the eye 4202 of the user. Further, pupil 4208 and/or glint 4210 may be tracked over a period of time to determine a user's gaze.

In one example, eye-tracking subsystem 4200 may be configured to identify and measure the inter-pupillary distance (IPD) of a user. In some embodiments, eye-tracking subsystem 4200 may measure and/or calculate the IPD of the user while the user is wearing the artificial reality system. In these embodiments, eye-tracking subsystem 4200 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 4100 and/or eye-tracking subsystem 4200 may be incorporated into any of the augmented-reality systems in and/or virtual-reality systems described herein in to enable these systems to perform various eye-tracking tasks (including one or more of the eye-tracking operations described herein).

As noted above, the present disclosure may also include haptic fluidic systems that involve the control (e.g., stopping, starting, restricting, increasing, etc.) of fluid flow through a fluid channel. The control of fluid flow may be accomplished with a fluidic valve. FIG. 43 shows a schematic diagram of a fluidic valve 4300 for controlling flow through a fluid channel 4310, according to at least one embodiment of the present disclosure. Fluid from a fluid source (e.g., a pressurized fluid source, a fluid pump, etc.) may flow through the fluid channel 4310 from an inlet port 4312 to an outlet port 4314, which may be operably coupled to, for example, a fluid-driven mechanism, another fluid channel, or a fluid reservoir.

Fluidic valve 4300 may include a gate 4320 for controlling the fluid flow through fluid channel 4310. Gate 4320 may include a gate transmission element 4322, which may be a movable component that is configured to transmit an input force, pressure, or displacement to a restricting region 4324 to restrict or stop flow through the fluid channel 4310. Conversely, in some examples, application of a force, pressure, or displacement to gate transmission element 4322 may result in opening restricting region 4324 to allow or increase flow through the fluid channel 4310. The force, pressure, or displacement applied to gate transmission element 4322 may be referred to as a gate force, gate pressure, or gate displacement. Gate transmission element 4322 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 43, gate 4320 of fluidic valve 4300 may include one or more gate terminals, such as an input gate terminal 4326(A) and an output gate terminal 4326(B) (collectively referred to herein as “gate terminals 4326”) on opposing sides of gate transmission element 4322. Gate terminals 4326 may be elements for applying a force (e.g., pressure) to gate transmission element 4322. By way of example, gate terminals 4326 may each be or include a fluid chamber adjacent to gate transmission element 4322. Alternatively or additionally, one or more of gate terminals 4326 may include a solid component, such as a lever, screw, or piston, that is configured to apply a force to gate transmission element 4322.

In some examples, a gate port 4328 may be in fluid communication with input gate terminal 4326(A) for applying a positive or negative fluid pressure within the input gate terminal 4326(A). A control fluid source (e.g., a pressurized fluid source, a fluid pump, etc.) may be in fluid communication with gate port 4328 to selectively pressurize and/or depressurize input gate terminal 4326(A). In additional embodiments, a force or pressure may be applied at the input gate terminal 4326(A) in other ways, such as with a piezoelectric element or an electromechanical actuator, etc.

In the embodiment illustrated in FIG. 43, pressurization of the input gate terminal 4326(A) may cause the gate transmission element 4322 to be displaced toward restricting region 4324, resulting in a corresponding pressurization of output gate terminal 4326(B). Pressurization of output gate terminal 4326(B) may, in turn, cause restricting region 4324 to partially or fully restrict to reduce or stop fluid flow through the fluid channel 4310. Depressurization of input gate terminal 4326(A) may cause gate transmission element 4322 to be displaced away from restricting region 4324, resulting in a corresponding depressurization of the output gate terminal 4326(B). Depressurization of output gate terminal 4326(B) may, in turn, cause restricting region 4324 to partially or fully expand to allow or increase fluid flow through fluid channel 4310. Thus, gate 4320 of fluidic valve 4300 may be used to control fluid flow from inlet port 4312 to outlet port 4314 of fluid channel 4310.

### EXAMPLE EMBODIMENTS

Example 1: A method comprising, (i) identifying, using a machine-learning-based summarization model, interests of a user of a social media network, (ii) extracting, using the machine-learning-based summarization model, information from a post to the social media network that aligns with the user's interests, and (iii) generating using the machine-learning-based summarization model, a personalized notification message for the user that is based on the information extracted from the post that aligns with the user's interests.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

What is claimed is:

1. A method comprising:
identifying, using a machine-learning-based summarization model, interests of a user of a social media network;
extracting, using the machine-learning-based summarization model, information from a post to the social media network that aligns with the user's interests; and
generating, using the machine-learning-based summarization model, a personalized notification message for the user that is based on the information extracted from the post that aligns with the user's interests.

2. An apparatus comprising a first airflow path through a sound-sensing structure and the second low-impedance airflow path. The first and the second airflow paths pass through an input port and an output port of an external enclosure (product enclosure).

3. An apparatus comprising a first airflow path through a sound-sensing structure and the second low-impedance airflow path. The first and the second airflow paths pass through a first port and a second port.
